(19) United States
(12) Patent Application Publication
(10) Pub. No.: US 2011/0190923 A1
(43) Pub. Date: Aug. 4, 2011

(54) Three-dimensional modeling apparatus, method of manufacturing a three-dimensional object, and three-dimensional object

(75) Inventors: Takeshi Matsui, Tokyo (JP); Junichi Kuzusako, Saitama (JP); Hiroyuki Yasukochi, Kanagawa (JP)

(73) Assignee: Sony Corporation, Tokyo (JP)

(21) Appl. No.: 12/929,316

(22) Filed: Jan. 14, 2011

(30) Foreign Application Priority Data
Jan. 29, 2010 (JP) 2010-017934

(51) Int. Cl. G06F 19/00

(52) U.S. Cl. 700/118

(57) ABSTRACT

A three-dimensional modeling apparatus includes a stage, a movement mechanism, first and second supply mechanisms, and a head. To the stage, a modeling material is supplied. The movement mechanism moves the stage in a predetermined direction. The first supply mechanism and the second supply mechanism are disposed along the predetermined direction. The first and second supply mechanisms supply the modeling material onto the stage that is moved by the movement mechanism. The head discharges a liquid to the modeling material on the stage. The liquid is capable of hardening the modeling material supplied from at least one of the first supply mechanism and the second supply mechanism.

### BACKGROUND OF THE INVENTION

1. Field of the Invention

The present invention relates to a three-dimensional modeling apparatus that forms a three-dimensional shape by laminating pieces of cross-sectional image data, to a method of manufacturing a three-dimensional object, and to a three-dimensional object.

2. Description of the Related Art

In the past, a three-dimensional modeling apparatus of this type has been known as an apparatus of rapid prototyping, which is widespread for commercial use. As main methods for the three-dimensional modeling apparatus, stereo lithography, laminated object manufacturing, and modeling with powders, for example.

In the stereo lithography, light-curing resin is irradiated with high-power laser light to form a cross-sectional shape, and cross-sectional shapes are laminated, thereby forming a three-dimensional shape. In the laminated object manufacturing, thin sheets are cut out in a layer form, the cutout sheets are bonded and laminated, thereby forming the three-dimensional shape. In the modeling with powders, powder materials are bedded in a layer form to form a cross-sectional shape, and cross-sectional shapes are laminated, thereby forming a three-dimensional shape.

The modeling with powders is roughly classified into a method in which powders are molten or sintered and a method in which powders are solidified by an adhesive. In the latter method, powders, the main component of which is plaster, are solidified by discharging an adhesive thereto with an inkjet head used for a printing apparatus or the like, and cross-sectional layers are formed and laminated, thereby forming a three-dimensional shape.

In the modeling with powders by using an inkjet head, from the head of an inkjet printer, a binding solution for binding the powders is discharged, with the head being moved on a sheet on which the powdered plaster are bedded as if printing is performed.

An apparatus that uses the aforementioned modeling with powders is disclosed. As shown in FIG. 1 of Japanese Patent Application Laid-open No. 2001-334581 (hereinafter, referred to as Patent Document 1), two powder supply mechanisms (22a and 22b) are provided and moved to continuously supply powder materials onto a modeling stage (50), thereby forming a powder layer (see, for example, paragraphs 0020 to 0028 and FIG. 1 of Patent Document 1).

### SUMMARY OF THE INVENTION

In the aforementioned apparatus, since the powder supply mechanisms are moved, powders are moved in the mechanisms due to the vibration caused by the movement of the powder supply mechanisms, which tends to cause a trouble such as an uneven band. Further, as the modeling progresses, the amount of powders in the powder supply mechanisms is reduced. Therefore, along with the movement, the powders in the mechanisms tend to move and lean to one side, which further makes the supply of the powders unstable. For this reason, there arises a problem in that it may be impossible to form the powder layers on the modeling stage with a uniform thickness in a plane.

In view of the above-mentioned circumstances, it is desirable to provide a three-dimensional modeling apparatus capable of forming a modeling material layer having a uniform thickness without being affected by the vibration caused by a movement of a supply mechanism for a modeling material, a method of manufacturing a three-dimensional object, and a three-dimensional object.

According to an embodiment of the present invention, there is provided a three-dimensional modeling apparatus including a stage, a movement mechanism, first and second supply mechanisms, and a head.

To the stage, a modeling material is supplied.

The movement mechanism moves the stage in a predetermined direction.

The first supply mechanism and the second supply mechanism are disposed along the predetermined direction, and supply the modeling material onto the stage that is moved by the movement mechanism.

The head discharges a liquid to the modeling material on the stage. The liquid is capable of hardening the modeling material supplied from at least one of the first supply mechanism and the second supply mechanism.

In the embodiment of the present invention, since the stage is moved by the movement mechanism, it is possible to supply the modeling material without moving the first supply mechanism and the second supply mechanism in a direction parallel to the movement direction of the stage. Therefore, it is possible to fix the first supply mechanism and the second supply mechanism in position, which prevents vibrations due to the movement of the first supply mechanism and the second supply mechanism. As a result, it is possible to supply the modeling material from the first supply mechanism and the second supply mechanism stably with a supply amount being constant, and therefore the modeling material can be deposited on the stage with a uniform thickness in the plane. Further, since the two supply mechanisms, that is, the first supply mechanism and the second supply mechanism are provided along the movement direction of the stage, one reciprocating movement of the stage makes it possible to form two layers, i.e., a deposition layer formed of the modeling material supplied from the first supply mechanism and a deposition layer formed of the modeling material supplied from the second supply mechanism. Thus, it is possible to reduce a modeling time period as compared to a three-dimensional modeling apparatus provided with one supply mechanism.

The head may discharge the liquid to the modeling material on the stage that is moved by the movement mechanism.

Since the stage is moved by the movement mechanism, it is possible to discharge the liquid without moving the head in a direction parallel to the movement direction of the stage. Therefore, it is possible to fix the head in position, which prevents vibrations due to the movement of the head. Accordingly, it is possible to discharge the liquid to the modeling material on the stage stably with a discharge amount being constant, and therefore the modeling material can be deposited on the stage with a uniform thickness in the plane.

The head may be disposed between the first supply mechanism and the second supply mechanism along the predetermined direction.

With this structure, it is possible to discharge the liquid from one head to the modeling material supplied from the first supply mechanism and to the modeling material supplied from the second supply mechanism.

At least one of the first supply mechanism and the second supply mechanism may include a supply box, a deposition surface, and a drop mechanism.

The supply box is capable of storing the modeling material and is disposed above the stage in a movement path of the stage.

The deposition surface is disposed to be inclined in the supply box. On the deposition surface, the modeling material is deposited.

The drop mechanism causes, during movement of the stage, the modeling material deposited on the deposition surface to drop onto the stage by self-weight of the modeling material.

During the movement of the stage by the movement mechanism, the modeling material is supplied from the deposition surface onto the stage by using at least the self-weight thereof. Therefore, the supply mechanism does not have to perform the movement for layering one layer of the modeling material on the stage. That is, it is possible to fix the supply mechanism in the three-dimensional modeling apparatus, which makes the structure of the movement system simple.

The first supply mechanism and the second supply mechanism may supply the same modeling material.

The first supply mechanism and the second supply mechanism may supply different modeling materials.

The first supply mechanism and the second supply mechanism may supply a modeling material that is a powder.

The stage may include a plurality of stages.

With this structure, it is possible to form a plurality of three-dimensional objects at the same time in one three-dimensional modeling apparatus.

According to another embodiment of the present invention, there is provided a method of manufacturing a three-dimensional object including moving of a stage in a predetermined direction.

During movement of the stage, a modeling material is supplied onto the stage by a first supply mechanism and a second supply mechanism that are disposed along the predetermined direction.

A liquid is discharged to the modeling material on the stage. The liquid is capable of hardening the modeling material supplied from at least one of the first supply mechanism and the second supply mechanism.

According to another embodiment of the present invention, there is provided a three-dimensional object obtained by the manufacturing method described above.

As described above, according to the embodiments of the present invention, it is possible to form a modeling material layer having a uniform thickness on the stage without being affected by the vibrations due to the movement of the modeling material supply mechanism.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a three-dimensional (hereinafter, abbreviated as 3-D) modeling apparatus according to a first embodiment of the present invention;

FIG. 2 are perspective views each showing the 3-D modeling apparatus of FIG. 1 when viewed from a side thereof;

FIG. 3 is a perspective view showing the internal structure of the 3-D modeling apparatus when approximately the center of the 3-D modeling apparatus is taken along a plane parallel to a Y direction in FIG. 1;

FIG. 4 is a view (cross-sectional view) showing the 3-D modeling apparatus when FIG. 3 is viewed from a front side thereof;

FIG. 5 is a perspective view showing the 3-D modeling apparatus in the state where all the covers thereof are removed in FIG. 1;

FIG. 6 is a plan view of the 3-D modeling apparatus shown in FIG. 5;

FIG. 7 is a perspective view showing the 3-D modeling apparatus shown in FIG. 5, from which a print base plate is detached;

FIG. 8 is a block diagram mainly showing a control system of the 3-D modeling apparatus;

FIG. 9 are cross-sectional views (part 1) showing operations of the 3-D modeling apparatus according to the first embodiment;

FIG. 10 are cross-sectional views (part 2) showing operations subsequent to the operations shown in FIG. 9;

FIG. 11 are cross-sectional views (part 3) showing operations subsequent to the operations shown in FIG. 10;

FIG. 12 are cross-sectional views (part 4) showing operations subsequent to the operations shown in FIG. 11;

FIG. 13 are cross-sectional views (part 5) showing operations subsequent to the operations shown in FIG. 12;

FIG. 14 is a perspective view showing the internal structure of a 3-D modeling apparatus according to a second embodiment of the present invention, when approximately the center of the 3-D modeling apparatus is taken along a plane parallel to the Y direction;

FIG. 15 is a view (cross-sectional view) showing the 3-D modeling apparatus when FIG. 14 is viewed from a front side thereof;

FIG. 16 are cross-sectional views (part 1) showing operations of the 3-D modeling apparatus according to the second embodiment;

FIG. 17 are cross-sectional views (part 2) showing operations subsequent to the operations shown in FIG. 16;

FIG. 18 are cross-sectional views (part 3) showing operations subsequent to the operations shown in FIG. 17;

FIG. 19 are cross-sectional views (part 4) showing operations subsequent to the operations shown in FIG. 18;

FIG. 20 are cross-sectional views (part 5) showing operations subsequent to the operations shown in FIG. 19;

FIG. 21 are cross-sectional views (part 6) showing operations subsequent to the operations shown in FIG. 20;

FIG. 22 is a schematic view of a 3-D modeling apparatus according to another embodiment;

FIG. 23 is a schematic view of a 3-D modeling apparatus according to another embodiment;

FIG. 24 is a schematic view of a 3-D modeling apparatus according to another embodiment;

FIG. 25 is a schematic view of a 3-D modeling apparatus according to another embodiment;

FIG. 26 is a schematic view of a 3-D modeling apparatus according to another embodiment; and FIG. 27 is a schematic view of a 3-D modeling apparatus according to another embodiment.

### DESCRIPTION OF PREFERRED EMBODIMENTS

Hereinafter, embodiments of the present invention will be described with reference to the drawings.

### First Embodiment

(Structure of Three-Dimensional Modeling Apparatus)

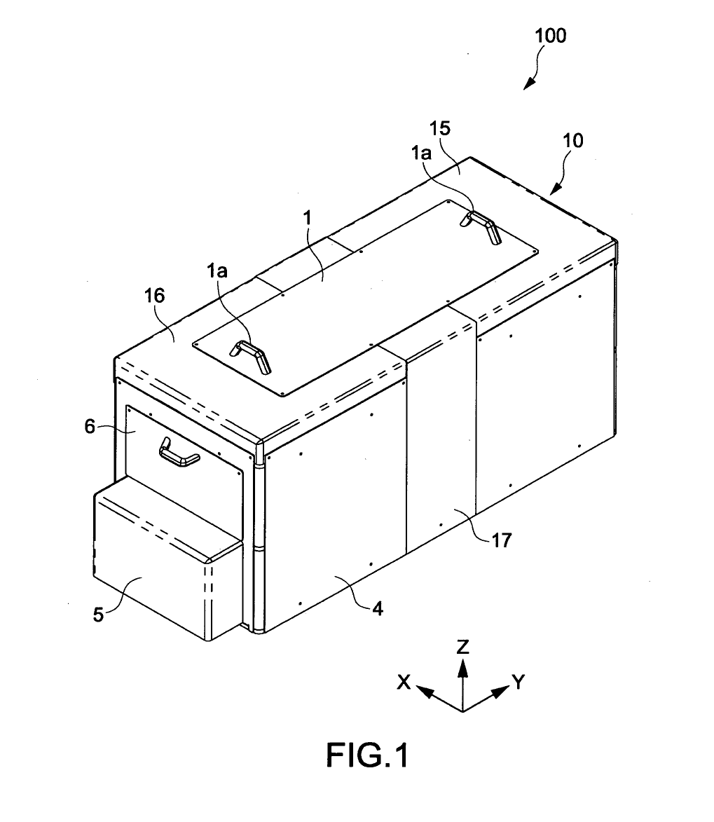

FIG. 1 is a diagram showing a three-dimensional (hereinafter, abbreviated as 3-D) modeling apparatus according to a first embodiment of the present invention.

A 3-D modeling apparatus 100 is provided with a casing that is constituted of several covers and has an approximately rectangular parallelepiped shape. The upper portion of the casing is constituted of a top cover 1, a right cover 15, and a left cover 16. The top cover 1 is sandwiched between the right cover 15 and the left cover 16 from-the both sides thereof. In addition, a front surface cover 4, a center cover 17, both side surface covers 5, and a back surface cover (not shown in FIG. 1) are provided. To the top cover 1, handles la are attached, and the top cover 1 is attachable to and detachable from the right cover 2 and the left cover 3.

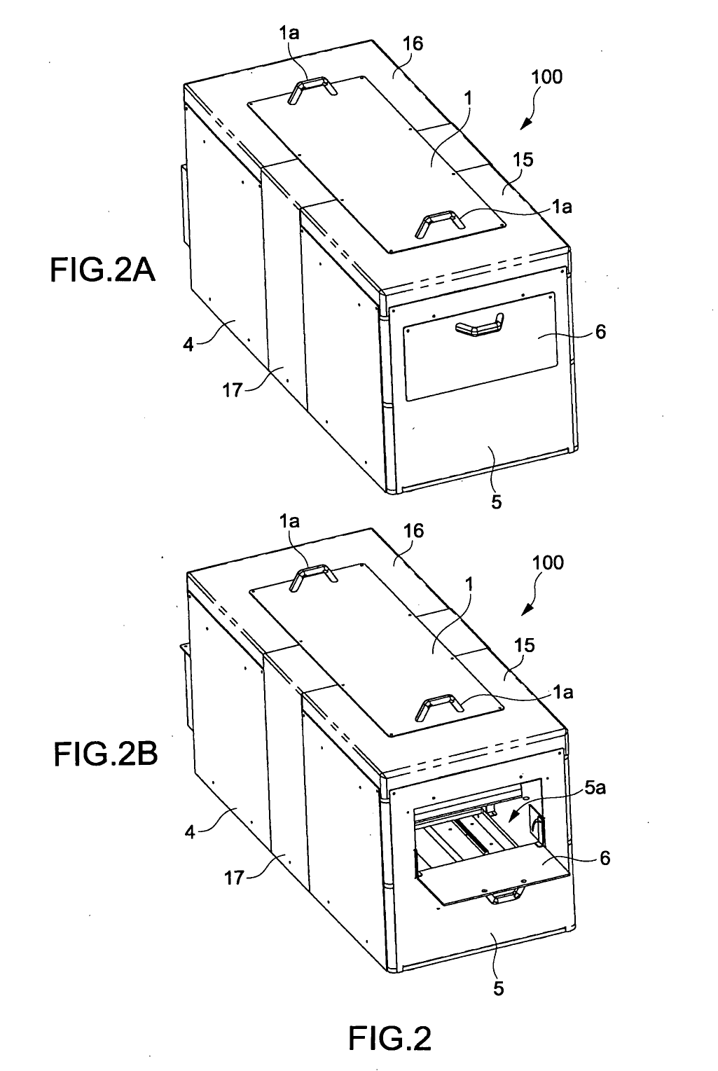

FIGS. 2A and 2B are perspective views when viewed from the side surface of the 3-D modeling apparatus 100. As shown in FIGS. 1, 2A, and 2B, a takeout opening 5a, from which a formed 3-D object is taken out, is formed on each of the side surface covers 5. A takeout cover 6 is provided to each of the takeout openings 5a so as to be opened and closed.

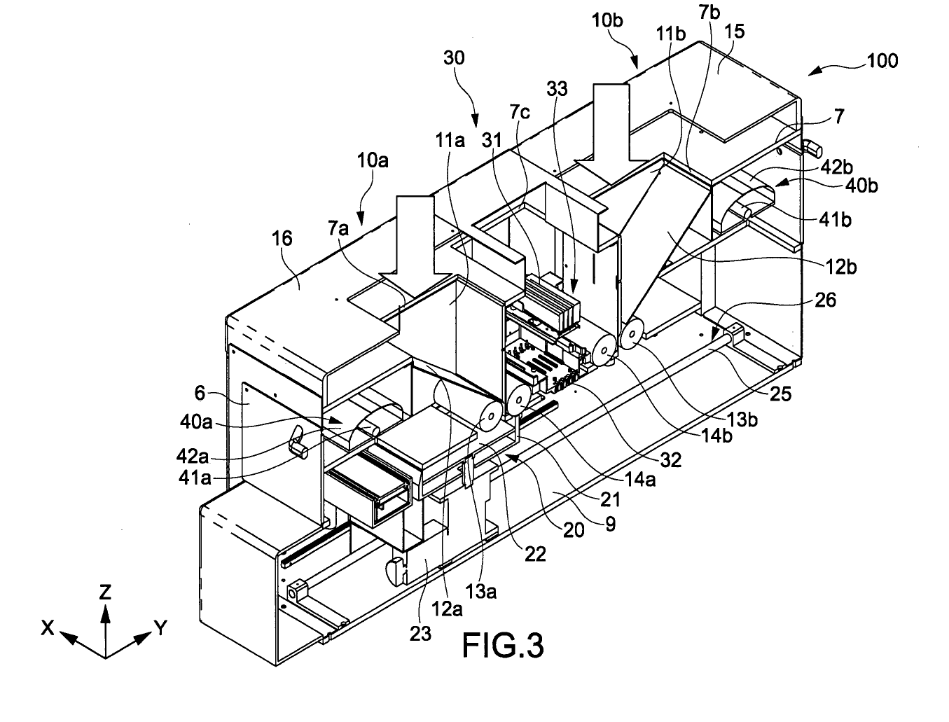

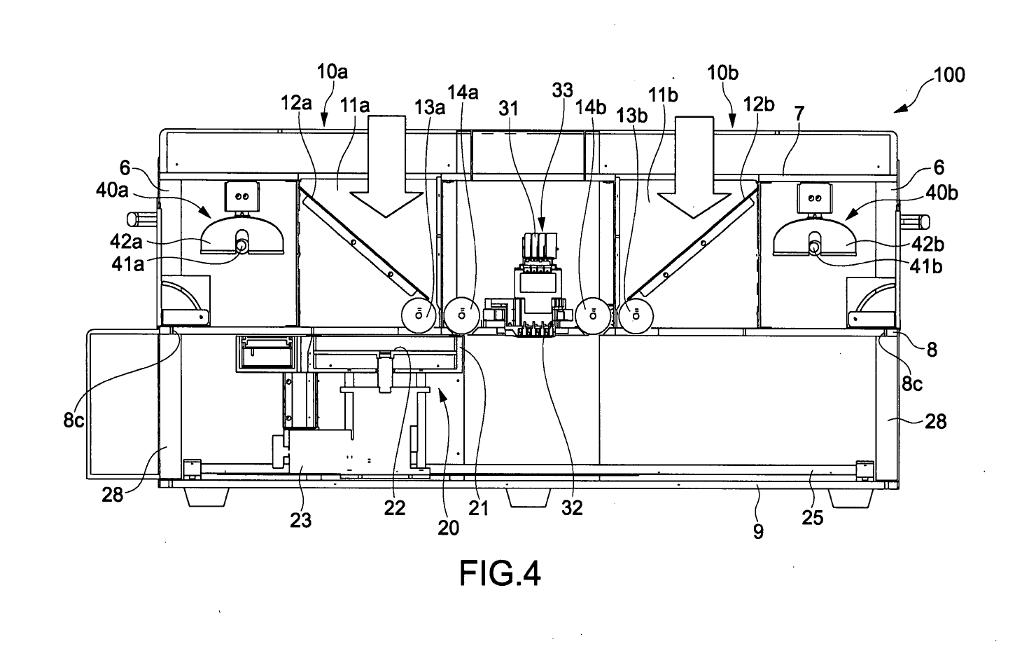

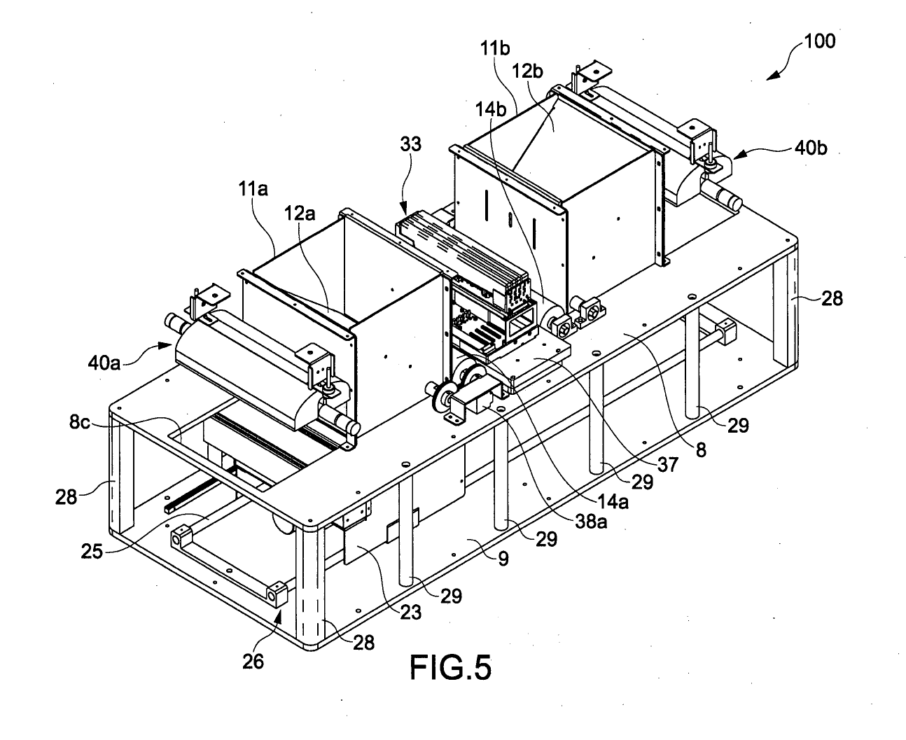

FIG. 3 is a perspective view showing the internal structure of the 3-D modeling apparatus 100 when approximately the center of the 3-D modeling apparatus 100 is taken along a plane parallel to a Y direction in FIG. 1. FIG. 4 is a view (cross-sectional view) showing the 3-D modeling apparatus 100 when FIG. 3 is viewed from the front side thereof. FIG. 5 is a perspective view showing the 3-D modeling apparatus 100 in the state where all the covers thereof are removed in FIG. 1.

As shown in FIG. 5, the 3-D modeling apparatus 100 is provided with four support columns 28 at four corners, respectively, for example. The 3-D modeling apparatus 100 is further provided with a base plate 9, a print base plate 8, and a top plate 7 that are connected with the support columns 28 so as to be arranged in a Z-axis direction in order at predetermined intervals. Between the three plates, a plurality of column members 29 is provided as appropriate.

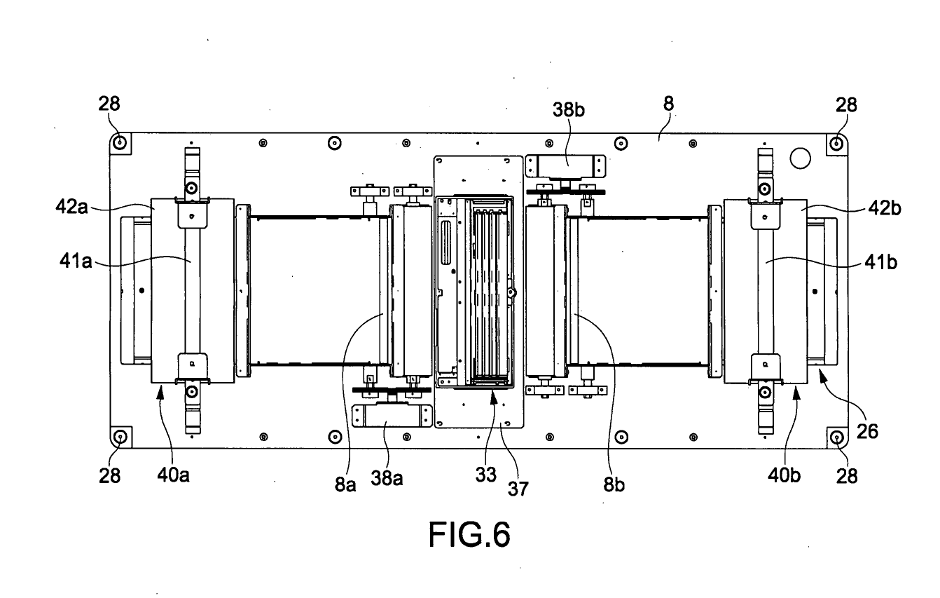

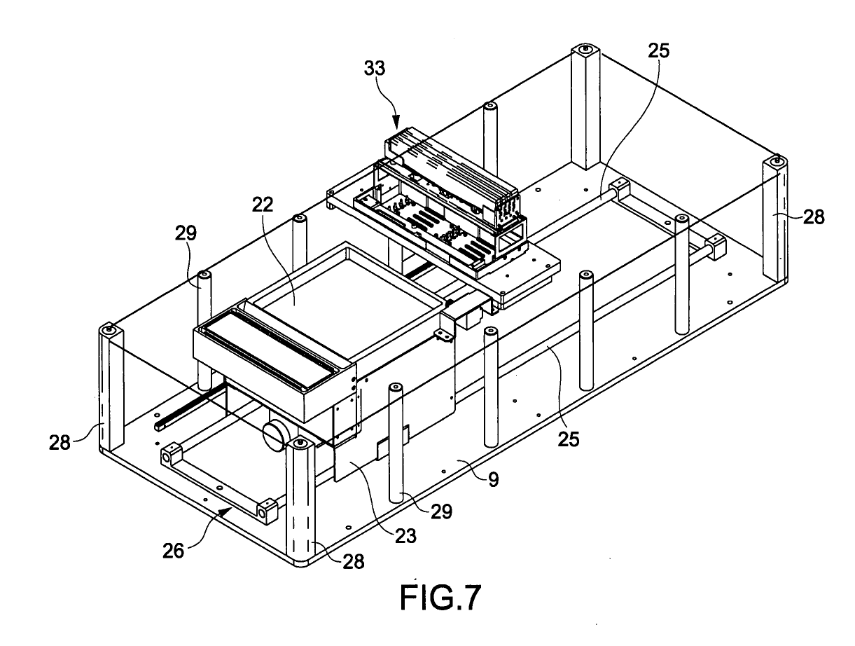

FIG. 6 is a plan view of the 3-D modeling apparatus 100 shown in FIG. 5. FIG. 7 is a perspective view showing the 3-D modeling apparatus 100 shown in FIG. 5, from which the print base plate 8 is detached. As shown in FIGS. 4 to 7, on the print base plate 8, a first heater 40a, a first supply unit 10a as a first supply mechanism, a head unit 30, a second supply unit 10b as a second supply mechanism, and a second heater 40b are disposed in order along the Y direction that is the longitudinal direction of the 3-D modeling apparatus 100. The first supply unit 10a (second supply unit 10b) supplies powder materials (hereinafter, simply referred to as powders) as modeling materials to a first modeling box 21a (second modeling box 21b) of a first modeling unit 20a (second modeling unit 20b).

As the powders, water-soluble materials are used. For example, an inorganic material, such as salt, magnesium sulfate, magnesium chloride, potassium chloride, and sodium chloride, is used. A material obtained by mixing sodium chloride with bittern (magnesium sulfate, magnesium chloride, potassium chloride, or the like) may be used. That is, the material contains sodium chloride as the main component. Alternatively, it is also possible to use a material, such as polyvinylpyrrolidone, polyvinyl alcohol, carboxymethyl cellulose, ammonium polyacrylate, sodium polyacrylate, ammonium methacrylate, and sodium methacrylate, which contains the aforementioned inorganic material as the main component, or an organic material such as a copolymer thereof. Polyvinylpyrrolidone or the like exerts a desirable bonding property by adding water thereto and being subjected to heating. The average particle diameter of the powders is typically 10 μm or more and 100 μm or less. The use of salt involves lower energy for extracting or processing the powder materials as compared to the case where powder materials such as metal and plastic, which is environmentally friendly. In addition, since an edible material such as salt and polyvinylpyrrolidone is used, even if the material is discarded, an environment is not adversely affected.

In the top plate 7, openings 7a and 7b are formed. From the openings 7a and 7b, an operator or an operation robot supplies the powders to the first supply unit 10a and the second supply unit 10b. Further, in the top plate 7, a loading and unloading opening 7c is formed between the openings 7a and 7b so as to be adjacent thereto. From the loading and unloading opening 7c, the operator or the like loads and unloads an ink tank unit 33 (described later) in the head unit 30.

As shown in FIG. 6, in lower parts of the first supply unit 10a and the second supply unit 10b, square holes 8a and 8b are formed in the print base plate 8. The shape or the size of the holes 8a and 8b may be designed as appropriate. For example, the holes 8a and 8b may have a slit shape elongated in an X direction that is perpendicular to the Y direction, as long as the powders can drop in a first modeling box 21a and a second modeling box 21b as will be described later.

As shown in FIG. 4, below a first heater 40a and a second heater 40b, takeout openings 8c are formed in the print base plate 8. From the takeout openings 8c, a 3-D object formed is taken out.

Below the print base plate 8, a modeling unit 20 in which a 3-D object with the powders is formed is disposed. The modeling unit 20 is provided with a modeling box 21 and a modeling stage 22 that is provided in the modeling box 21. The modeling box 21 stores the powders supplied from the first supply unit 10a and the second supply unit 10b. On the modeling stage 22, the powders are deposited. In addition, the modeling unit 20 is provided with a lifting and lowering unit (lifting and lowering mechanism) 23 that supports the modeling box 21 and the modeling stage 22, and lifts and lowers the modeling stage 22 in the modeling box 21.

The first supply unit 10a (second supply unit 10b) is provided with a first supply box 11a (second supply box 11b), a first deposition plate 12a (second deposition plate 12b), and a first supply roller 13a (second supply roller 13b) as a drop mechanism. The first supply box 11a (second supply box 11b) is capable of storing the powders. The first deposition plate 12a (second deposition plate 12b) is disposed in the first supply box 11a (second supply box 11b) at a slant. The first supply roller 13a (second supply roller 13b) is disposed at a lower end portion of the first deposition plate 12a (second deposition plate 12b). An upper portion of the first supply box 11a (second supply box 11b) has an opening portion that faces the opening 7a (opening 7b) of the top plate 7. The first supply box 11a (second supply box 11b) has an approximately cubic shape, for example. The first deposition plate 12a is inclined at approximately 40 to 50 degrees from a horizontal plane (X-Y plane), for example, and is disposed so that a deposition surface (upper surface) serving as a surface on which the powders are deposited is directed toward the head unit 30, that is, in a positive Y direction. The second deposition plate 12b is inclined at approximately 40 to 50 degrees from the horizontal plane (X-Y plane), for example, and is disposed so that a deposition surface (upper surface) serving as a surface on which the powders are deposited is directed toward the head unit 30, that is, in a negative Y direction. The powders are deposited on the first deposition plate 12a (second deposition plate 12b), and are thus stored in a triangular prism region in the first supply box 11a (second supply box 11b).

The inclination of the first deposition plate 12a (second deposition plate 12b) is not limited to 40 to 50 degrees, and may be set at such an angle that the powders do not adhere to the deposition surface due to the friction and flows down into the modeling box 21 of the modeling unit 20, as will be described later. In other words, the inclinations of the first deposition plate 12a and the second deposition plate 12b are capable of being set as appropriate depending on the kind of the material of the powders, the shape thereof, the material of the deposition surface, or the like.

The first supply roller 13a (second supply roller 13b) has a rotation shaft extended in the X direction, and has an elongated shape in the X direction within at least the range in which a 3-D object is formed in the X direction in the modeling box 21. The side wall of the first supply box 11a (second supply box 11b) on the head unit 30 side is disposed so that the lower end of the side wall is positioned on the surface of the first supply roller 13a (second supply roller 13b) with a predetermined gap. When the first supply roller 13a (second supply roller 13b) is rotated, the powders stored in the first supply box 11a (second supply box 11b) are supplied to the modeling box 21 through the predetermined gap. In addition, in the state where the first supply roller 13a (second supply roller 13b) is not rotated and stopped, the gap is set to be slight to such an extent that the powders on the first deposition plate 12a (second deposition plate 12b) are prevented from dropping into the modeling box 21.

The first supply unit 10a (second supply unit 10b) is provided with a first leveling roller 14a (second leveling roller 14b) that is aligned with the first supply roller 13a (second supply roller 13b) in the Y direction between the first supply box 11a (second supply box 11b) and the head unit 30. The first leveling roller 14a (second leveling roller 14b) is rotated, thereby leveling the surface of the powders stored on the modeling stage 22. The first supply box 11a (second supply box 11b), the first deposition plate 12a (second deposition plate 12b), the first supply roller 13a (second supply roller 13b), first leveling roller 14a (second leveling roller 14b), and the like function as the supply mechanism. The first leveling roller 14a (second leveling roller 14b) also has an elongated shape in the X direction within at least the range in which the 3-D object is formed in the X direction in the modeling box 21, like the first supply roller 13a (second supply roller 13b). As described above, the 3-D modeling apparatus 100 according to this embodiment is provided with the two supply mechanisms.

As shown in FIG. 3, on the base plate 9, a movement mechanism 26 is provided which moves the modeling unit 20 in the Y direction. On a side of the modeling box 21, which is opposite side to the head unit 30 side, a collecting box that collects extra powders is disposed and attached onto the lifting and lowering unit 23 or attached to a lower portion of the modeling box 21.

The lifting and lowering unit 23 is configured by a rack and pinion (not shown), a belt drive mechanism (not shown), or a linear motor (not shown) that is driven by an electromagnetic operation, for example. Instead of the lifting and lowering unit 23, a lifting and lowering cylinder that utilizes a fluid pressure may be used, for example.

As shown in FIGS. 3 and 4, the movement mechanism 26 is provided with a guide rail 25 and a drive mechanism for moving the lifting and lowering unit 23 in the Y direction along the guide rail 25. The guide rail 25 is provided on the base plate 9 so as to be extended in the Y direction. The drive mechanism is provided with a movement motor, a pinion gear, and a rack gear, for example. The pinion gear is driven by the movement motor. The pinion gear and the rack gear are engaged with each other. The movement motor is attached to, for example, the lifting and lowering unit 23 of the modeling unit 20. The drive mechanism may use various mechanisms such as a ball screw, a belt drive, a linear motor that is driven by an electromagnetic operation, or the like, in addition to the rack and pinion. With the movement mechanism 26 as described above, the modeling box 21, the modeling stage 22, the lifting and lowering unit 23, and the collecting box are integrally moved in the Y direction.

In a Y-direction movement path of the modeling unit 20 by the movement mechanism 26, in an area above the modeling unit 20 in the movement path, the first heater 40a, the first supply unit 10a, the head unit 30, the second supply unit 10b, and the second heater 40b are disposed.

The modeling box 21 has substantially the same footprint as the first supply box 11a and the second supply box lib. As shown in FIG. 6, in a position of the print base plate 8, in which the first leveling roller 14a and the second leveling roller 14b are disposed, exposure holes are formed which cause a part of the surface of each of the first leveling roller 14a and the second leveling roller 14b to be exposed downwards from the print base plate 8.

As shown in FIGS. 5 and 6, as a drive source that drives the first supply roller 13a (second supply roller 13b) and the first leveling roller 14a (second leveling roller 14b), a first rotation motor 38a (second rotation motor 38b) are provided on the print base plate 8. To a drive output shaft of the first rotation motor 38a (second rotation motor 38b), a transmission gear is connected. With the transmission gear, two gears, which are connected to the rotation shaft of the first supply roller 13a (second supply roller 13b) and the rotation shaft of the first leveling roller 14a (second leveling roller 14b), respectively, are engaged at a predetermined gear ratio. The gear ratio of the two gears to the transmission gear may be the same or may be different. The drive of the first rotation motor 38a (second rotation motor 38b) causes the transmission gear to rotate, and the rotation force is transmitted to the two gears, thereby rotating the first supply roller 13a (second supply roller 13b) and the first leveling roller 14a (second leveling roller 14b) in the same direction. In this way, the one drive source drives the first supply roller 13a (second supply roller 13b) and the first leveling roller 14a (second leveling roller 14b). As a result, it is possible to downsize the 3-D modeling apparatus 100. In addition, it is also possible to save the cost.

As shown in FIG. 3, the head unit 30 has an ink tank unit 33 and an inkjet head 32. The ink tank unit 33 is equipped with a plurality of ink tanks 31. The inkjet head 32 is connected to the ink tanks 31 through tubes (not shown). The inkjet head 32 discharges ink stored in the ink tanks 31 onto the powders on the modeling stage 22. As shown in FIG. 6 and the like, the inkjet head 32 is fixed to a support table 37 provided to the print base plate 8, and the ink tank unit 33 is disposed on the support table 37.

The ink jet head 32 uses a line-type head that is elongated in the X direction as shown in FIG. 7, for example. The discharge width for the ink in the X direction is designed within at least the range in which the 3-D object is formed in the X direction on the modeling stage 22. As a generation mechanism of the ink jet, a piezoelectric type and a thermal type are given as examples, and a known discharge principle may be used.

As the ink (liquid), for example, color ink such as cyan, magenta, and yellow (hereinafter, referred to as CMY) may be used. In addition to the color ink, ink such as black and white or colorless ink may be used. In particular, the ink tank 31 that contains the black ink, the white ink, or the colorless ink may be set in accordance with the color of the powders as appropriate. In this embodiment, for example, materials of the powders and ink that harden the powders by water contained in the ink are selected. In the case where the powders are white and the 3-D object is intended to be colored in white (intended to be kept white), the colorless ink or the white ink is discharged to the corresponding part.

Further, as the ink material, for example, aqueous-based ink is used, and commercially available ink for an ink jet printer may also be used. The ink may be an oil-based ink in accordance with the material of the powders. As the colorless ink, for example, a material obtained by mixing ethyl alcohol with pure water at a weight ratio of 1 to 1, a material obtained by mixing glycerin into pure water by approximately 5 wt % to 20 wt %, or a material obtained by mixing a minute amount of surfactants into the aforementioned mixture materials is used.

Alternatively, the material of the ink is not limited to the material for the coloring purpose. A medical agent including a binding agent for binding the particles of the powders to each other may be used.

The first heater 40a (second heater 40b) is provided with a first infrared lamp 41a (second infrared lamp 41b) and a first reflector 42a (second reflector 42b). Instead of the first infrared lamp 41a (second infrared lamp 41b) for heating, an electrically heated wire or an infrared laser (to be described later) may be used.

(Control System)

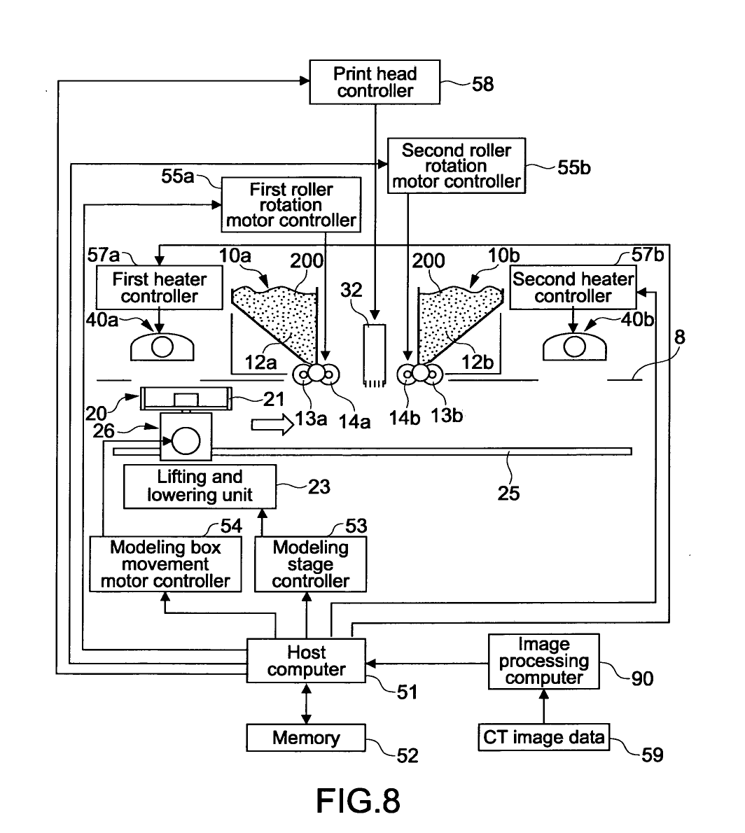

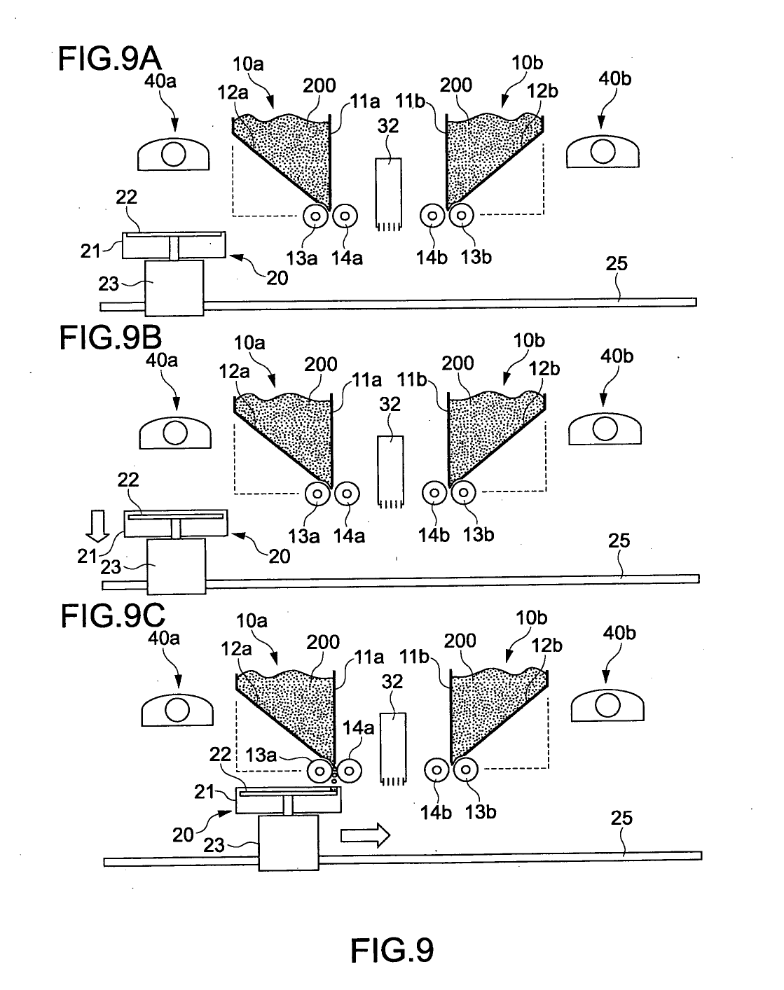

FIG. 8 is a block diagram mainly showing a control system of the 3-D modeling apparatus 100 described above.

The control system is provided with a host computer 51, a memory 52, an image processing computer 90, a modeling box movement motor controller 54, a modeling stage controller 53, a first roller rotation motor controller 55a, a second roller rotation motor controller 55b, a print head controller 58, a first heater controller 57a, and a second heater controller 57b.

The host computer 51 performs overall control of drives of various controllers and the memory 52. The memory 52 is connected to the host computer 51, and may be volatile or nonvolatile.

The image processing computer 90 loads a CT (computed tomography) image data 59 as a tomographic image of an object to be modeled as will be described later. An image processing such as a conversion into a BMP (bitmap) format or another format is performed with respect to the CT image data 59. Typically, the image processing computer 90 is a computer independent of the 3-D modeling apparatus 100, and is connected to the host computer 51 with a USB (universal serial bus) or the like, to transmit to the host computer 51 the stored image data that has been subjected to the image processing.

The CT is not limited to a CT using an X ray and means a CT in a broad sense that includes a SPECT (single photon emission CT), a PET (positron emission tomography), an MRI (magnetic resonance imaging), and the like.

The form of the connection between the host computer 51 and the image processing computer 90 is not limited to the USB but may be an SCSI (small computer system interface) or another form. In addition, it makes no difference whether a wired connection or a wireless connection is used. It should be noted that the image processing computer 90 may be a device for image processings which is provided in the 3-D modeling apparatus 100. Further, in the case where the image processing computer 90 is independent of the 3-D modeling apparatus 100, the image processing computer 90 may be a CT apparatus that generates image data.

At a time of an ink printing onto powders 200 with the inkjet head 32, the modeling stage controller 53 controls a lifting and lowering drive amount of the lifting and lowering unit in order to lower the modeling stage 22 on a predetermined height basis as will be described later.

The modeling box movement motor controller 54 controls the drive of the movement motor 38 of the movement mechanism 26, thereby controlling the start and stop of the movement of the modeling unit 20, the movement speed thereof, and the like.

The first roller rotation motor controller 55a (second roller rotation motor controller 55b) controls the drive of the first rotation motor 38a (second rotation motor 38b), thereby controlling the start and stop of the rotations of the first supply roller 13a (second supply roller 13b) and the first leveling roller 14a (second leveling roller 14b), the rotation speeds thereof, and the like.

The print head controller 58 outputs a drive signal to a generation mechanism of the inkjet in the inkjet head 32 in order to control the discharge amount of the ink.

The first heater controller 57a (second heater controller 57b) controls the start and stop of the heating by the first heater 40a (second heater 40b), a heating temperature, a heating period, and the like.

The host computer 51, the image processing computer 90, the modeling stage controller 53, the first roller rotation motor controller 55a, the second roller rotation motor controller 55b, the modeling box movement motor controller 54, the first heater controller 57a, and the second heater controller 57b only have to be implemented by the following hardware or by the hardware and software in combination. That is, examples of the hardware include a CPU (central processing unit), a DSP (digital signal processor), an FPGA (field programmable gate array), an ASIC (application specific integrated circuit), and the like.

The memory 52 may be a storage device such as a magnetic disk and an optical disk, in addition to a solid (semiconductor, dielectric, or magnetoresistive) memory.

(Operation of 3-D modeling apparatus 100)

A description will be given on operations of the 3-D modeling apparatus (and the image processing computer 90) structured as described above. FIGS. 9 to 13 are schematic cross-sectional views each showing the operations. In this embodiment, powder materials stored in the first supply box 11a of the first supply unit 10a are set to be the same as powder materials stored in the second supply box lib of the second supply unit 10b.

The image processing computer 90 reads CT image data. An object to be modeled is a living organism, in particular, a human body in a medical field. In addition to the medical field, CT image data used in an architecture field, a mechanical engineering field, or the like is capable of being treated.

First, an operator operates the image processing computer 90 or the host computer 51, to select a modeling target file, that is, a CT image data group corresponding to one object to be modeled, for example.

Based on luminance information of the CT image selected, the image processing computer 90 may perform a binarization process or a three-or-more-valued process with respect to the luminance. In this case, with respect to the image that has been subjected to the multivalued process, the image processing computer 90 may perform a coloring process in accordance with gradual luminances corresponding to the multivalued process. By the aforementioned multivalued process and the coloring process in accordance with the luminances, the 3-D modeling apparatus 100 is capable of modeling a 3-D object, the inside of which is color-coded or. colored.

The host computer 51 loads the CT image data group or the image data group that has been subjected to the aforementioned image processings (multivalued process, coloring process, and the like). Hereinafter, for convenience of explanation, the CT image data or the image-processed image data are collectively referred to as “tomographic image data”.

Next, for example, the operator operates the image processing computer 90, thereby specifying the thickness of each of cross sections of the tomographic image data. As will be described later, the thickness of one cross section of the tomographic image data corresponds to the thickness of one layer of the powders 200 at a time when a printing process is performed with respect to the powders 200 on the modeling stage 22.

The thickness of the one layer of the powders 200 may be less or more than the thickness of each of the cross sections of an original tomographic image data. For example, in the case where the thickness of each of the cross sections of the original tomographic image data is set to 1 mm, the thickness of the one layer of the powders 200 may be set to 0.1 mm. In this case, the 3-D modeling apparatus 100 only has to print the same image onto ten layers (0.1 mm×10) of the powders 200 in accordance with the corresponding tomographic image data. Alternatively, the thickness of the one layer of the powders 200 may be set to be the same as the thickness of each of the cross sections of the original tomographic image data.

Next, for example, when the operator presses a start button (not shown), the 3-D modeling apparatus 100 starts the operation.

As shown in FIG. 9A, to the modeling stage 22 of the modeling unit 20, the powders are not supplied. In this state, a process for forming one hardened layer is started.

First, by driving the lifting and lowering unit 23, the modeling stage 22 is lowered by a predetermined layer thickness, as shown in FIG. 9B. Next, as shown in FIG. 9C, the first rotation motor 38a is driven, thereby rotating the first supply roller 13a and the first leveling roller 14a. In FIG. 9, the rotation direction of the first supply roller 13a is clockwise, and the rotation direction of the first leveling roller 14a is counterclockwise. By rotating the first supply roller 13a and the first leveling roller 14a, the powders 200 deposited on the first deposition plate 12a of the first supply box 11a of the first supply unit 10a are flowed down via a gap between the lower end of the side wall of the first supply box 11a and the surface of the first supply roller 13a because of the self-weight of the powders 200 and the rotation force of the first supply roller 13a.

As described above, when the modeling stage 22 is moved in the Y direction (rightwards in the figure), the powders 200 are supplied from the deposition surface onto the modeling stage 22 by using at least the self-weight. Therefore, it is unnecessary to move the first supply roller 13a and the first leveling roller 14a in order to layer one layer of the powders 200 on the modeling stage 22. That is, it is possible to fix the first supply unit 10a to the 3-D modeling apparatus 100, which makes the structure of the movement system simple.

Further, by the driving of the movement mechanism 26, the modeling unit 20 is started to move toward the inkjet head 32 side approximately at the same time when the first supply roller 13a and the first leveling roller 14a are started to rotate or after a lapse of a predetermined time period from the timing. The rotations of the first supply roller 13a and the first leveling roller 14a are continued also during the movement of the modeling unit 20, and the supply of the powders 200 to the modeling box 21 is continued.

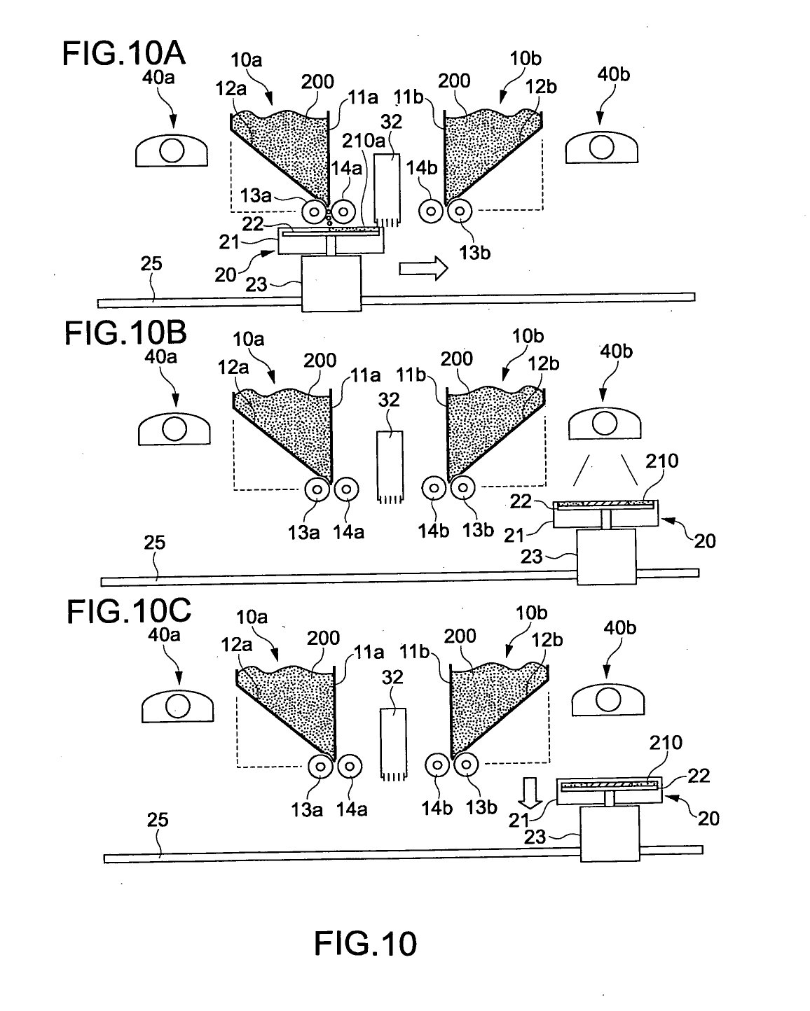

As shown in FIG. 10A, when the modeling unit 20 is moved to cause the first leveling roller 14a to be located above the modeling box 21, the surface of the powders 200 is leveled. Thus, a first powder layer 210a of one layer is deposited on the modeling stage 22. A thickness u of the one layer is set to, for example, 0.1 mm as described above.

Next, when the movement of the modeling unit 20 causes the modeling box 21 to move to a predetermined position, the inkjet head 32 starts to discharge ink based on the control of the print head controller 58. As a result, a first hardened layer 210 is formed which is obtained by hardening a predetermined selected area of the first powder layer 210a of the one layer deposited on the modeling stage 22. By appropriately selecting kinds of the ink and the material of the powders 200 which allow the powder particles to bind each other, it is possible to form a hardened layer. Commercially available aqueous-based ink can be a liquid for hardening the powders 200 that contain sodium chloride as the main component. Further, depending on the material of the powders 200, for example, in the case where the powders 200 are formed of a copolymer with the aforementioned organic materials, water serves as the liquid for hardening the material of the powders 200.

When the rear end portion (left end portion) of the moving modeling box 21 passes below the first leveling roller 14a, the first supply roller 13a and the first leveling roller 14a are stopped. Thus, the supply of the powders 200 to the modeling box 21 is stopped.

Further, by continuing the movement of the modeling unit 20, extra powders 200 that are spilled from the modeling box 21 are collected into the collection box. Therefore, the collected powders 200 can be reused.

Further, when the inkjet head 32 supplies ink to the entire predetermined selected area of the powder layer, the discharge is stopped. It should be noted that the supply process of the powders 200 onto the modeling stage 22 may be performed substantially concurrently with the ink discharge process.

When the movement of the modeling unit 20 in the Y direction (rightwards in the figure) is further continued, the modeling box 21 is moved to a position immediately below the second heater 40b as shown in FIG. 10B. In the position, the first hardened layer 210 of one layer on the modeling stage 22 is heated by the second heater 40b. The heating temperature is set to, for example, 100 to 200° C., but is not limited to this range. By the heating process, the hardness of the powders 200 in the hardened area of the first hardened layer is increased, and thus the powders are sintered. In the case where the binding force between the powder particles by the ink discharged from the head is insufficient, and the hardness of the object that has been modeled is insufficient, by performing heating with the second heater 40b, it is possible to obtain a desired hardness.

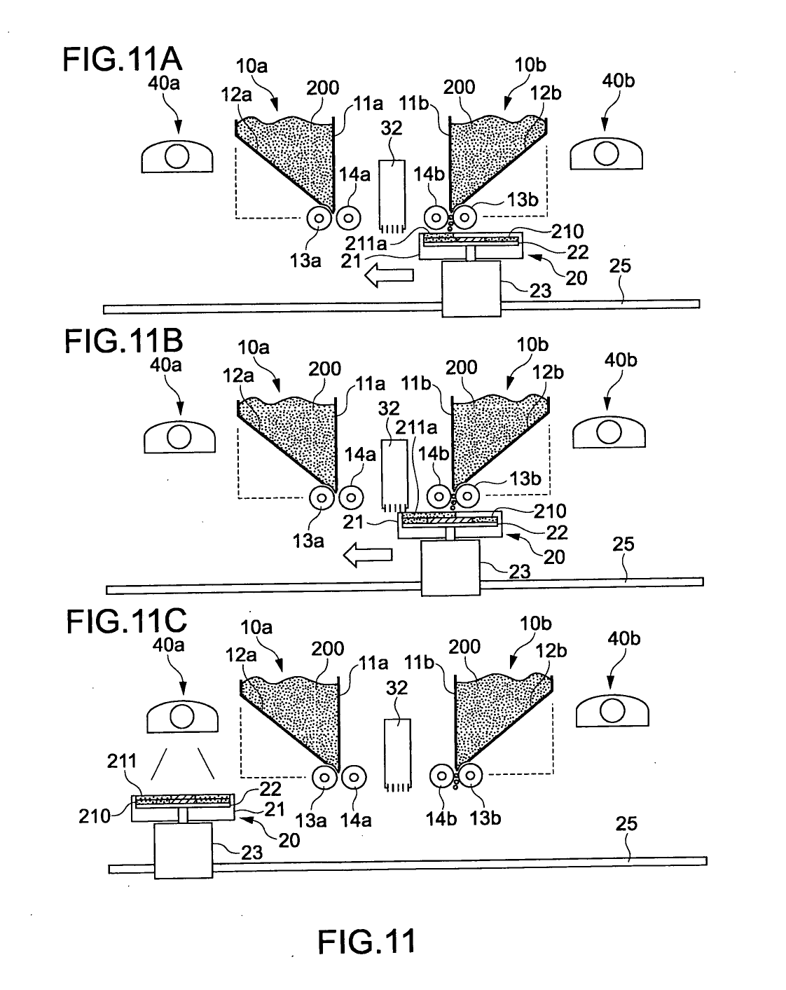

Then, by driving the lifting and lowering unit 23, the modeling stage 22 is lowered by the predetermined layer thickness as shown in FIG. 10C. Next, as shown in FIG. 11A, the second rotation motor 38b is driven, thereby rotating the second supply roller 13b and the second leveling roller 14b. In FIGS. 11A to 11C, the rotation direction of the second supply roller 13b is counterclockwise, and the rotation direction of the second leveling roller 14b is clockwise. By rotating the second supply roller 13b and the second leveling roller 14b, the powders 200 deposited on the second deposition plate 12b of the second supply box 11b of the second supply unit 10b are flowed down via a gap between the lower end of the side wall of the second supply box 11b and the surface of the second supply roller 13b because of the self-weight of the powders 200 and the rotation force of the second supply roller 13b.

As described above, when the modeling stage 22 is moved in the negative Y direction (leftwards in the figure), the powders 200 are supplied from the deposition surface onto the modeling stage 22 by using at least the self-weight. Therefore, it is unnecessary to move the second supply roller 13b and the second leveling roller 14b in order to layer one layer of the powders 200 on the modeling stage 22. That is, it is possible to fix the second supply unit 10b to the 3-D modeling apparatus 100, which makes the structure of the movement system simple.

Further, by the driving of the movement mechanism 26, the modeling unit 20 is started to move toward the inkjet head 32 side approximately at the same time when the second supply roller 13b and the second leveling roller 14b are started to rotate or after a lapse of a predetermined time period from the timing. The rotations of the second supply roller 13b and the second leveling roller 14b are continued during the movement of the modeling unit 20, and the supply of the powders 200 to the modeling box 21 is continued.

As shown in FIG. 11B, when the modeling unit 20 is moved to cause the second leveling roller 14b to be located above the modeling box 21, the surface of the powders 200 is leveled. Thus, a second powder layer 211a of one layer is deposited on the modeling stage 22. A thickness u of the one layer is set to, for example, 0.1 mm as described above.

Next, when the movement of the modeling unit 20 causes the modeling box 21 to be moved to a predetermined position, the inkjet head 32 starts to discharge ink based on the control of the print head controller 58. As a result, a second hardened layer 211 is formed which is obtained by hardening a predetermined selected area of the second powder layer 211a of the one layer deposited on the modeling stage 22.

When the rear end portion (right end portion) of the moving modeling box 21 passes below the second leveling roller 14b, the second supply roller 13b and the second leveling roller 14b are stopped. Thus, the supply of the powders 200 to the modeling box 21 is stopped.

Further, by continuing the movement of the modeling unit 20, extra powders 200 that are spilled from the modeling box 21 are collected into the collection box. Therefore, the collected powders 200 can be reused.

Further, when the inkjet head 32 supplies ink to the entire predetermined selected area of the powder layer, the discharge is stopped. It should be noted that the supply process of the powders 200 onto the modeling stage 22 may be performed substantially concurrently with the ink discharge process.

When the movement of the modeling unit 20 in the negative Y direction (leftwards in the figure) is further continued, the modeling box 21 is moved to a position immediately below the first heater 40a as shown in FIG. 11C. In the position, the second hardened layer 211 of one layer on the modeling stage 22 is heated by the first heater 40a. The heating temperature is set to, for example, 100 to 200° C., but is not limited to this range. By the heating process, the hardness of the powders 200 in the hardened area of the second hardened layer 211 is increased, and thus the powders are sintered. In the case where the binding force between the powder particles by the ink discharged from the head is insufficient, and the hardness of the object that has been modeled is insufficient, by performing heating with the first heater 40a, it is possible to obtain a desired hardness.

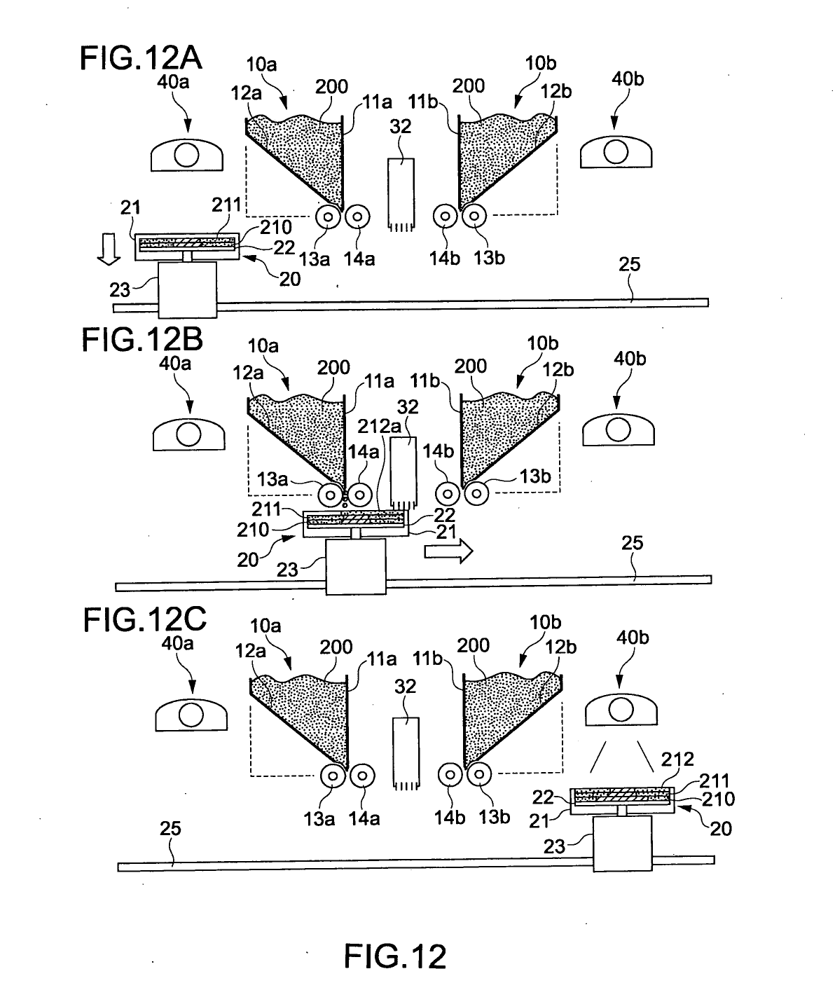

Then, by driving the lifting and lowering unit 23, the modeling stage 22 is lowered by the predetermined layer thickness as shown in FIG. 12A. Next, the second rotation motor 38b is driven, thereby rotating the first supply roller 13a and the first leveling roller 14a. In FIGS. 12A to 12C, the rotation direction of those rollers is clockwise. By rotating the first supply roller 13a and the first leveling roller 14a, the powders 200 deposited on the first deposition plate 12a of the first supply box 11a of the first supply unit 10a are flowed down via a gap between the lower end of the side wall of the first supply box 11a and the surface of the first supply roller 13a because of the self-weight of the powders 200 and the rotation force of the first supply roller 13a. Thus, on the second hardened layer 211 on the modeling stage 22, a third powder layer 212a is deposited.

As described above, when the modeling stage 22 is moved in the Y direction (rightwards in the figure), the powders 200 are supplied from the deposition surface onto the modeling stage 22 by using at least the self-weight.

Further, by the driving of the movement mechanism 26, the modeling unit 20 is started to move toward the inkjet head 32 side approximately at the same time when the first supply roller 13a and the first leveling roller 14a are started to rotate or after a lapse of a predetermined time period from the timing. The rotations of the first supply roller 13a and the first leveling roller 14a are continued also during the movement of the modeling unit 20, and the supply of the powders 200 to the modeling box 21 is continued.

As shown in FIG. 12B, when the modeling unit 20 is moved to cause the first leveling roller 14a to be located above the modeling box 21, the surface of the powders 200 is leveled.

Next, when the movement of the modeling unit 20 causes the modeling box 21 to be moved to a predetermined position, the inkjet head 32 starts to discharge the ink based on the control of the head scan controller 56. As a result, a third hardened layer 212 is formed which is obtained by hardening a predetermined selected area of the third powder layer 212a of the one layer deposited on the modeling stage 22.

When the rear end portion (left end portion) of the moving modeling box 21 passes below the first leveling roller 14a, the first supply roller 13a and the first leveling roller 14a are stopped. Thus, the supply of the powders 200 to the modeling box 21 is stopped.

Further, by continuing the movement of the modeling unit 20, the extra powders 200 that are spilled from the modeling box 21 are collected into the collection box. Therefore, the collected powders 200 can be reused.

Further, when the inkjet head 32 supplies the ink to the entire predetermined selected area of the powder layer, the discharge is stopped. It should be noted that the supply process of the powders 200 onto the modeling stage 22 may be performed substantially concurrently with the ink discharge process.

When the movement of the modeling unit 20 in the Y direction (rightwards in the figure) is further continued, the modeling box 21 is moved to a position immediately below the second heater 40b as shown in FIG. 12C. In the position, the third hardened layer 212 of one layer on the modeling stage 22 is heated by the second heater 40b. By the heating process, the hardness of the powders 200 in the hardened area of the third hardened layer 212 is increased, and thus the powders are sintered.

Next, the modeling stage 22 that has been returned to the position immediately below the second heater 40b is lowered by the predetermined layer thickness by driving the lifting and lowering unit 23. Then, the modeling unit 20 is moved in the negative Y direction (leftwards in the figure), and the series of processes including the supply of the powders from the supply box, the discharge of the ink, and the heating with the heater is performed in the same way as above. As a result, as shown in FIG. 13A, a fourth hardened layer 213 is formed. The modeling unit 20 is disposed immediately below the first heater 40a.

Next, the modeling stage 22 that has been returned to the position immediately below the first heater 40a is lowered by the predetermined layer thickness by driving the lifting and lowering unit 23. Then, the modeling unit 20 is moved in the Y direction (rightwards in the figure), and the series of processes including the supply of the powders from the supply box, the discharge of the ink, and the heating with the heater is performed in the same way as above. As a result, as shown in FIG. 13B, a fifth hardened layer 214 that is the last layer is formed. It should be noted that although the fifth layer is the last layer in this embodiment, actually, the number of layers is 300 to 500 or more, and the series of processes is repeated until a desired number of modeled layers of the modeling data is obtained.

When the heating process is terminated, the host computer 51 judges whether the printing of all the tomographic images corresponding to the target object is completed or not. In the case where the printing is completed, the 3-D object is covered with unhardened powder layer, and the extra powders 200 in the modeling box 21 are removed, with the result that the 3-D object is completed. Then, as shown in FIG. 13C, a 3-D object 215 is taken out of the 3-D modeling apparatus 100 manually or with a robot (not shown).

In the case where the printing of all the tomographic images corresponding to the target object is not completed, the modeling unit 20 is moved in the Y direction from the position immediately below the first supply box 11a or in the negative Y direction from the position immediately below the second supply box 11b, and the series of processes including the supply of the powders, the discharge of the ink, and the heating with the heater is repeated.

As described above, in this embodiment, the modeling unit 20 is moved by the movement mechanism 26, so it is possible to supply the powders 200 and discharge the ink without moving the supply unit 10 and the inkjet head 32 in the Y direction. In other words, it is possible to supply the powders 200 and the ink only by moving the modeling unit 20 with the movement mechanism 26, which makes the structure of the movement system simple. The movement system refers to a mechanism for moving the members necessary for modeling the 3-D object by the predetermined layer thickness of the powders 200.

In this embodiment, the modeling stage 22 is provided movably along the Y axis, and in the movement direction, the two boxes, i.e., the first supply box 11a and the second supply box 11b are disposed. With this structure, the modeling stage 22 is moved in the Y direction, thereby making it possible to supply the powders from the first supply box 11a onto the modeling stage 22, and the modeling stage 22 is moved in the negative Y direction, thereby making it possible to supply the powders from the second supply box 11b onto the modeling stage 22. Thus, it is possible to deposit two powder layers by one reciprocating movement of the modeling stage 22. As a result, it is possible to reduce a modeling time period as compared to the case where only one supply box is provided. In other words, in the case where the one modeling box is provided, the modeling stage is moved from the home position in the positive Y direction to cause the powder layer to be deposited, and in order to deposit the next powder layer, the modeling stage that has been moved in the positive Y direction has to be moved in the negative Y direction to be returned to the home position. That is, in the reciprocating movement of the modeling stage, the powder layer is deposited only in an outward way. In contrast, in this embodiment, since the two modeling boxes are provided, it is possible to deposit the powder layer in each of the outward way and the return way, which makes it possible to significantly reduce the modeling time period. Therefore, the 3-D modeling apparatus 100 according to this embodiment is suitable for a mass production of products.

In this embodiment, since the reduction of the modeling time period is possible, it is possible to prevent a discharge failure due to ink drying. That is, in the case where only one supply box is provided, the ink is not discharged in the return way of the movement of the modeling stage, so the ink drying tends to occur, which may cause the discharge failure of the ink. In contrast, in this embodiment, the ink is discharged also in the return way of the movement of the modeling stage, so it is possible to minimize the chances of the ink drying.

In this embodiment, the supply box in which the powders are stored is fixed, and the modeling stage is moved, thereby performing the modeling. Therefore, vibrations due to the movement of the supply box do not occur, so it is possible to stably supply the powders from the supply boxes with the supply amount being kept constant. As a result, it is possible to deposit the powder layer on the modeling stage with the uniform thickness in the plane. In the case where the modeling stage is fixed, and the supply box that supplies the powders is moved to supply the powder layer, the movement of the supply box causes the vibrations, which makes the supply amount of the powders instable. Therefore, the thickness of the powder layer deposited on the modeling stage tends to vary in the plane. In contrast, in this embodiment, since the supply box is fixed in position, it is possible to stably supply powders by the desired amount.

In this embodiment, the movement of the modeling unit 20 by the movement mechanism 26 may be performed at a constant speed, or may be accelerated or decelerated during the movement.

In this embodiment, the 3-D object is modeled by the powder materials containing salts and the like, and the object is printed with the ink that does not contain an adhesive as in the related art. Therefore, it is possible to cut the cost of the ink. Since the adhesive is not used, it is possible to overcome the problem of a set of the adhesive at the discharge outlet of the inkjet head, which makes it possible to prevent clogging of the discharge opening.

### Second Embodiment

(Structure of 3-D Modeling Apparatus)

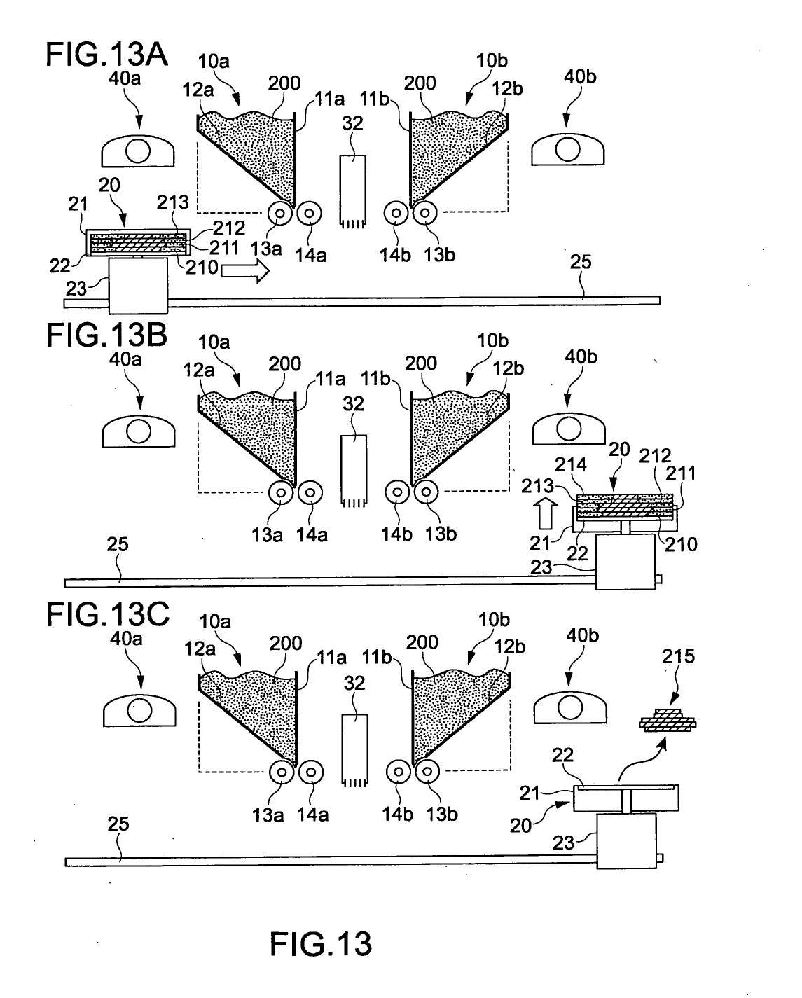

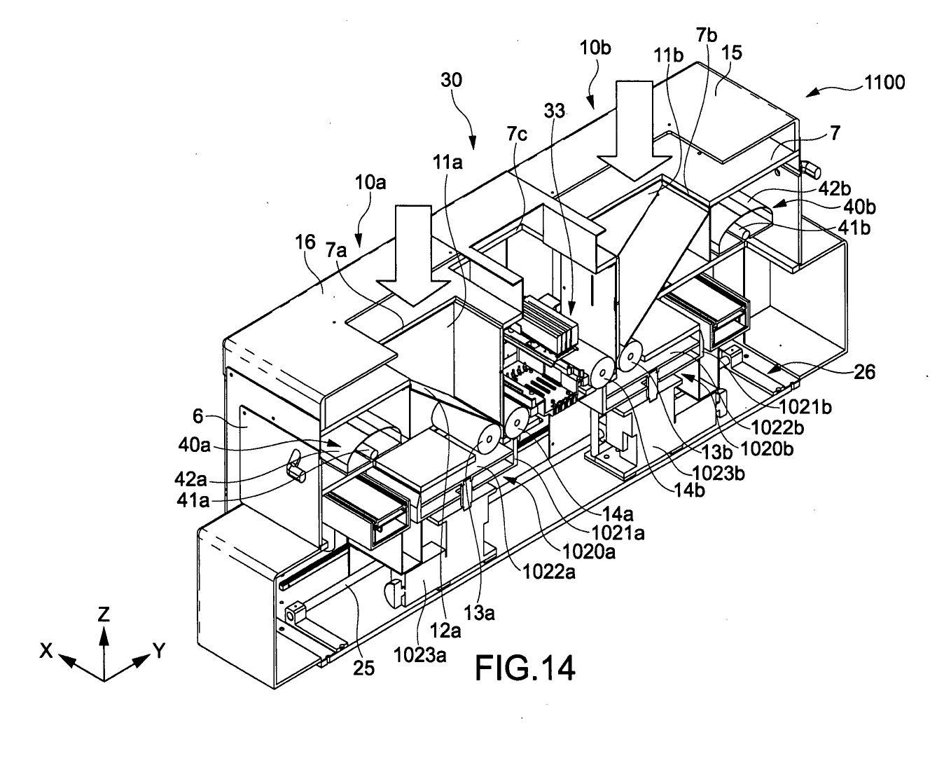

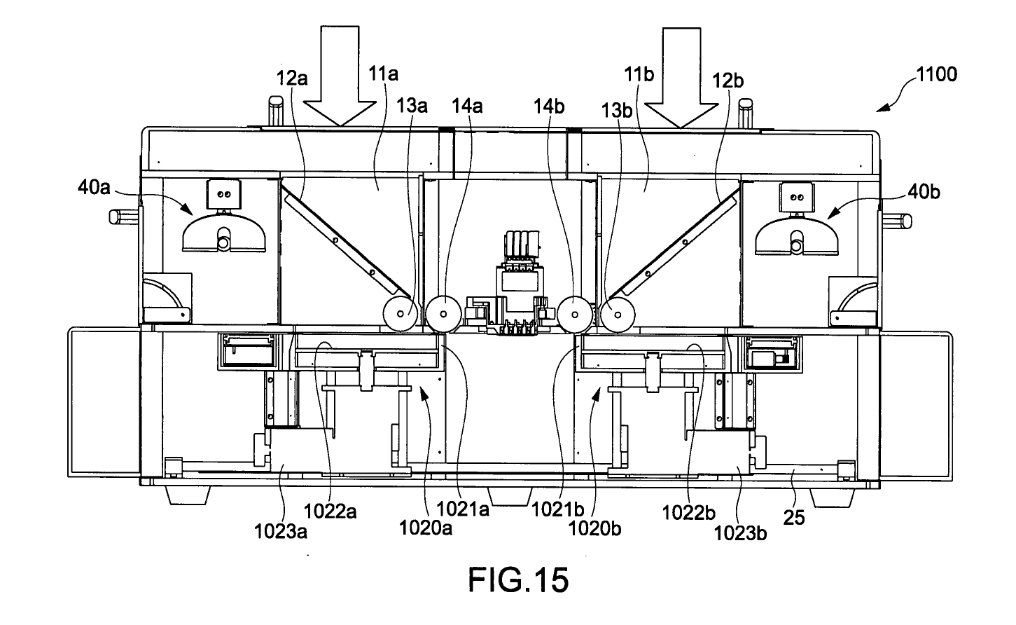

FIG. 14 is a perspective view showing the internal structure of a 3-D modeling apparatus 1100 according to a second embodiment of the present invention, when approximately the center of the 3-D modeling apparatus 1100 is taken along a plane parallel to a Y direction. FIG. 15 is a view (cross-sectional view) showing the 3-D modeling apparatus 1100 when FIG. 14 is viewed from the front side. The structures that are the same as those of the first embodiment are denoted by the same reference numerals and symbols, and their description will be simplified or omitted. Different points will be mainly described.

The 3-D modeling apparatus 1100 according to this embodiment is largely different from the 3-D modeling apparatus 100 according to the first embodiment in that the number of modeling unit is not one but two.

As shown in FIGS. 14 and 15, the 3-D modeling apparatus 1100 is provided with two modeling units, i.e., a first modeling unit 1020a and a second modeling unit 1020b. The first modeling unit 1020a (second modeling unit 1020b) includes a first modeling box 1021a (second modeling box 1021b) and the first modeling stage 1022a (second modeling stage 1022b). The first modeling unit 1020a (second modeling unit 1020b) stores the powders supplied from the first supply unit 10a and the second supply unit 10b. The first modeling stage 1022a (second modeling stage 1022b) on which the powders are deposited is disposed in the first modeling box 1021a (second modeling box 1021b). Further, the first modeling unit 1020a (second modeling unit 1020b) includes a first lifting and lowering unit 1023a (second lifting and lowering unit 1023b). The first lifting and lowering unit 1023a (second lifting and lowering unit 1023b) supports the first modeling box 1021a (second modeling box 1021b) and the first modeling stage 1022a (second modeling stage 1022b), and lifts and lowers the first modeling stage 1022a (second modeling stage 1022b) in the first modeling box 1021a (second modeling box 1021b).

(Operation of 3-D Modeling Apparatus 1100)

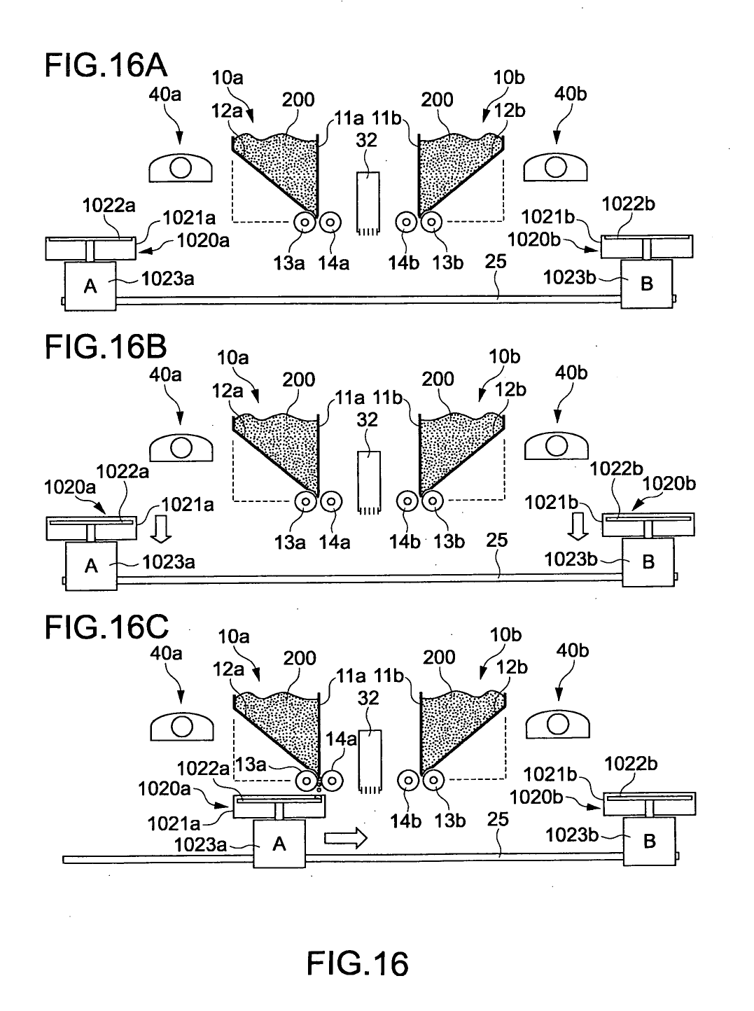

A description will be given on an example of operations of the 3-D modeling apparatus 1100 structured as described above. FIGS. 16 to 21 are schematic cross-sectional views each showing the operations. In this embodiment, powder materials stored in the first supply box 11a of the first supply unit 10a are set to be the same as powder materials stored in the second supply box 11b of the second supply unit 10b.

First, the image processing computer reads CT image data. An object to be modeled is a living organism, in particular, a human body in a medical field. In addition to the medical field, CT image data used in an architecture field, a mechanical engineering field, or the like is capable of being treated.

An operator operates the image processing computer or the host computer, to select a modeling target file, that is, a CT image data group corresponding to one object to be modeled, for example.

Next, for example, the operator operates the image processing computer, thereby specifying the thickness of each of cross sections of the tomographic image data. The thickness of one cross section of the tomographic image data corresponds to the thickness of one layer of the powders 200 at a time when a printing process is performed with respect to the powders 200 on the modeling stage 22.

Subsequently, for example, when the operator presses a start button (not shown), the 3-D modeling apparatus 1100 is started to operate.

As shown in FIG. 16A, to the first modeling stage 1022a of the first modeling unit 1020a and the second modeling stage 1022b of the second modeling unit 1020b, the powders are not supplied. In this state, a process for forming one hardened layer is started. The positions of the first modeling unit 1020a and the second modeling unit 1020b shown in FIG. 16A are home positions of the modeling units.

First, by driving the first lifting and lowering unit 1023a (second lifting and lowering unit 1023b), the first modeling stage 1022a (second modeling stage 1022b) is lowered by a predetermined layer thickness, as shown in FIG. 16B. Next, as shown in FIG. 16C, the first rotation motor 38a is driven, thereby rotating the first supply roller 13a and the first leveling roller 14a. In FIG. 16, the rotation direction of the first supply roller 13a is clockwise, and the rotation direction of the first leveling roller 14a is counterclockwise. By rotating the first supply roller 13a and the first leveling roller 14a, the powders 200 deposited on the first deposition plate 12a of the first supply box 11a of the first supply unit 10a are flowed down via a gap between the lower end of the side wall of the first supply box 11a and the surface of the first supply roller 13a because of the self-weight of the powders 200 and the rotation force of the first supply roller 13a.

As described above, when the first modeling stage 1022a is moved in the Y direction (rightwards in the figure), the powders 200 are supplied from the first deposition surface 12a onto the modeling stage 22 by using at least the self-weight.

Further, by the driving of the movement mechanism 26, the first modeling unit 1020a is started to move toward the inkjet head 32 side approximately at the same time when the first supply roller 13a and the first leveling roller 14a are started to rotate or after a lapse of a predetermined time period from the timing. The rotations of the first supply roller 13a and the first leveling roller 14a are continued also during the movement of the first modeling unit 1020a, and the supply of the powders 200 to the first modeling box 1021a is continued.

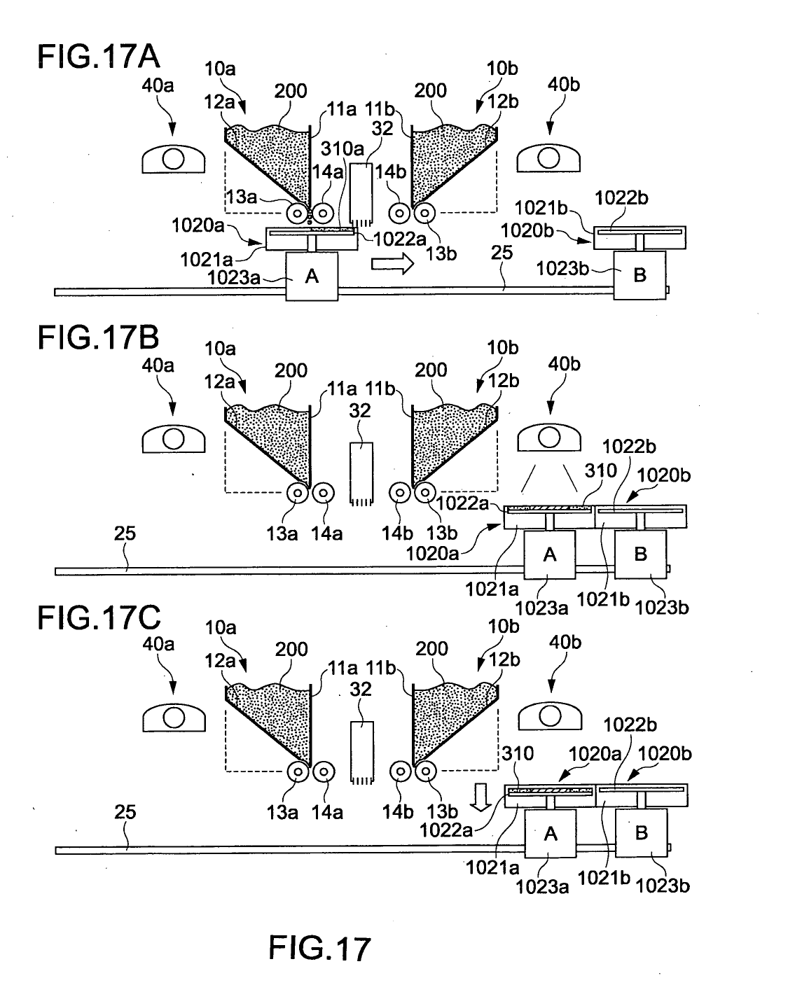

As shown in FIG. 17A, when the first modeling unit 1020a is moved to cause the first leveling roller 14a to be located above the first modeling box 1021a, the surface of the powders 200 is leveled. Thus, a first powder layer 310a of one layer is deposited on the first modeling stage 1022a.

Next, when the movement of the first modeling unit 1020a causes the first modeling box 1021a to be moved to a predetermined position, the inkjet head 32 starts to discharge ink based on the control of the head scan controller. As a result, a first hardened layer 310 is formed which is obtained by hardening a predetermined selected area of the first powder layer 310a of the one layer deposited on the modeling stage 22.

When the rear end portion (left end portion) of the moving first modeling box 1021a passes below the first leveling roller 14a, the first supply roller 13a and the first leveling roller 14a are stopped. Thus, the supply of the powders 200 to the first modeling box 1021a is stopped.

Further, when the inkjet head 32 supplies ink to the entire predetermined selected area of the powder layer, the discharge is stopped. It should be noted that the supply process of the powders 200 onto the first modeling stage 1022a may be performed substantially concurrently with the ink discharge process.

When the movement of the first modeling unit 1020a in the Y direction (rightwards in the figure) is further continued, the first modeling box 1021a is moved to a position immediately below the second heater 40b as shown in FIG. 17B. In the position, the first hardened layer 310 of one layer on the first modeling stage 1022a is heated by the second heater 40b. The heating temperature is set to, for example, 100 to 200° C., but is not limited to this range. By the heating process, the hardness of the powders 200 in the hardened area of the first hardened layer is increased, and thus the powders are sintered. In the case where the binding force between the powder particles by the ink discharged from the head is insufficient, and the hardness of the object that has been modeled is insufficient, by performing heating with the second heater 40b, it is possible to obtain a desired hardness.

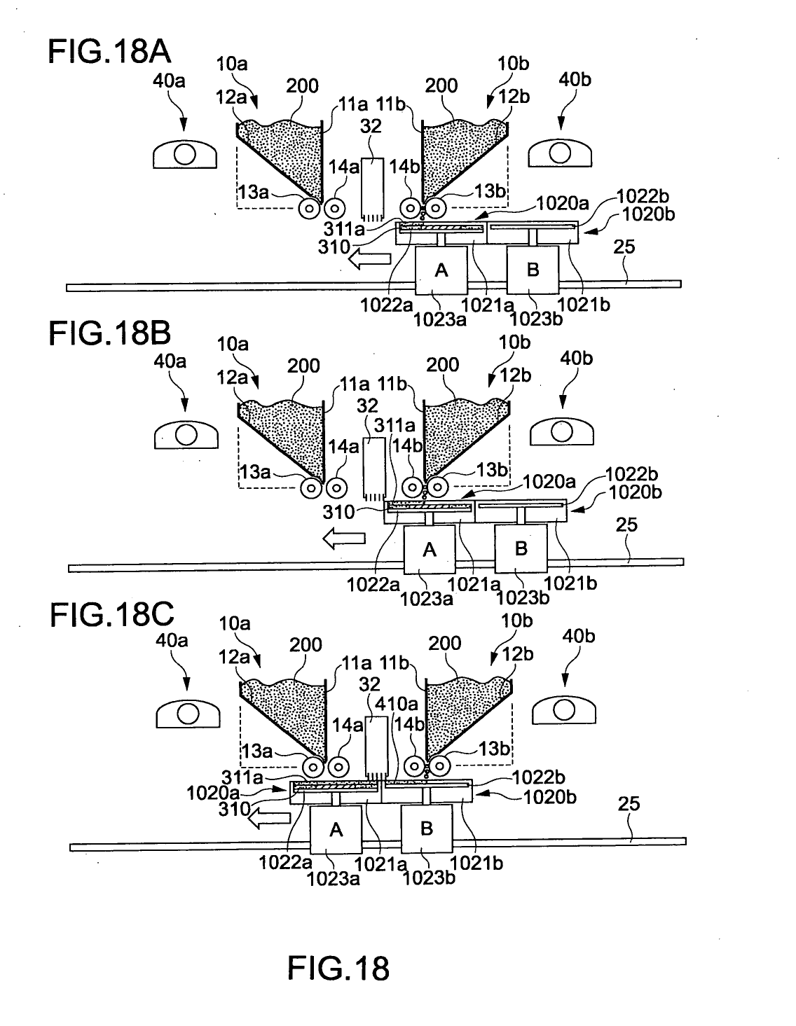

Then, by driving the first lifting and lowering unit 1023a, the first modeling stage 1022a is lowered by the predetermined layer thickness as shown in FIG. 17C. Next, as shown in FIG. 18A, the second rotation motor 38b is driven, thereby rotating the second supply roller 13b and the second leveling roller 14b. In FIGS. 18A to 18C, the rotation direction of the second supply roller 13b is counterclockwise, and the rotation direction of the second leveling roller 14b is clockwise. By rotating the second supply roller 13b and the second leveling roller 14b, the powders 200 deposited on the second deposition plate 12b of the second supply box 11b of the second supply unit 10b are flowed down via a gap between the lower end of the side wall of the second supply box 11b and the surface of the second supply roller 13b because of the self-weight of the powders 200 and the rotation force of the second supply roller 13b.

As described above, when first the modeling stage 1022a and the second modeling stage 1022b are being moved in the negative Y direction (leftwards in the figure), the powders 200 are supplied from the second deposition surface 12b onto the first modeling stage 1022a and the second modeling stage 1022b in succession by using at least the self-weight.

Further, by the driving of the movement mechanism 26, the first modeling unit 1020a and the second modeling unit 1020b are started to move toward the inkjet head 32 side approximately at the same time when the second supply roller 13b and the second leveling roller 14b are started to rotate or after a lapse of a predetermined time period from the timing. The rotations of the second supply roller 13b and the second leveling roller 14b are continued also during the movement of the first modeling unit 1020a and the second modeling unit 1020b, and the supply of the powders 200 to the first modeling box 1021a and the second modeling box 1021b is continued.

As shown in FIG. 18B, when the first modeling unit 1020a is moved to cause the second leveling roller 14b to be located above the second modeling box 1021a, the surface of the powders 200 is leveled. Thus, a second powder layer 311a is deposited on the first modeling stage 1022a. Subsequently, as shown in FIG. 18C, a first powder layer 410a is deposited on the second modeling stage 1022b.

Next, when the movement of the first modeling unit 1020a causes the first modeling box 1021a to be moved to a predetermined position, the inkjet head 32 starts to discharge ink based on the control of the print head controller. As a result, a second hardened layer 311 is formed which is obtained by hardening a predetermined selected area of the second powder layer 311a deposited on the first modeling stage 1022a. Subsequently, by the discharge of the ink, a first hardened layer 410 is formed which is obtained by hardening a predetermined selected area of the first powder layer 410a deposited on the second modeling stage 1022b.

When the rear end portion (right end portion) of the moving second modeling box 1021b passes below the second leveling roller 14b, the second supply roller 13b and the second leveling roller 14b are stopped. Thus, the supply of the powders 200 to the first modeling box 1021a and the second modeling box 1021b is stopped.

Further, when the inkjet head 32 supplies the ink to the entire predetermined selected areas of the powder layers, the discharge is stopped.

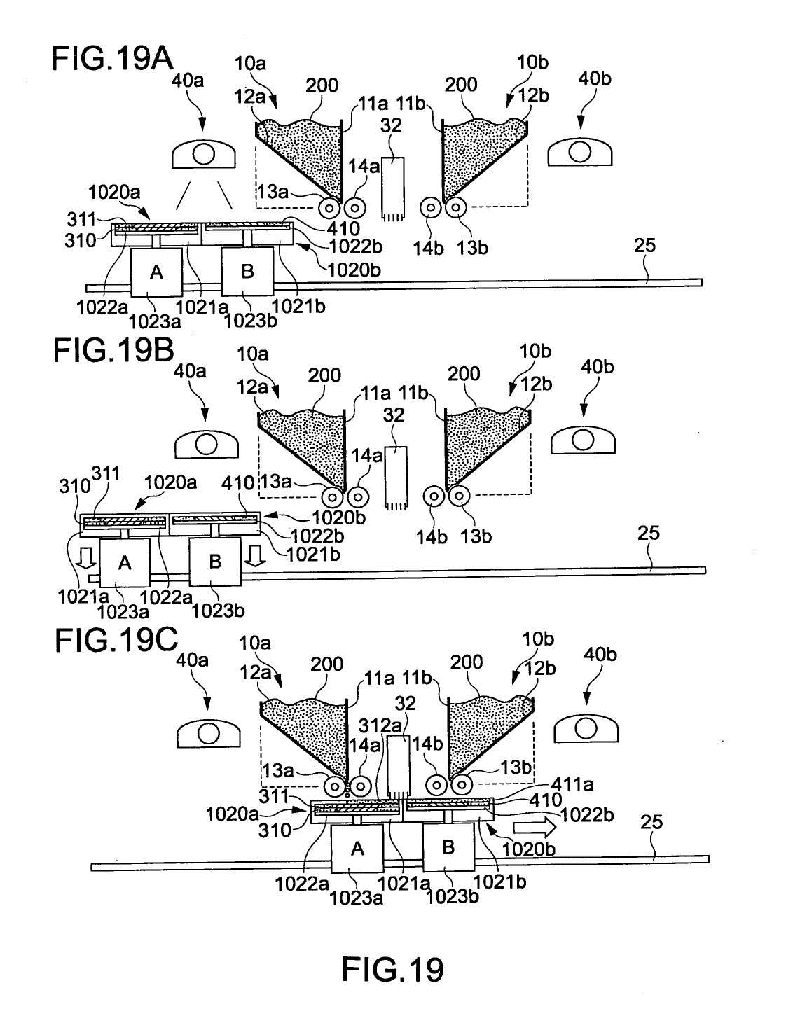

When the movement of the first modeling unit 1020a and the second modeling unit 1020b in the negative Y direction (leftwards in the figure) is further continued, the first modeling box 1021a and the second modeling box 1021b are moved to a position immediately below the first heater 40a as shown in FIG. 19A. In the position, the second hardened layer 311 on the first modeling stage 1022a and the first hardened layer 410 on the second modeling stage 1022b are heated by the first heater 40a. The heating temperature is set to, for example, 100 to 200° C., but is not limited to this range. By the heating process, the hardness of the powders 200 in the hardened area of the second hardened layer 311 and the hardness of the powders 200 in the hardened area of the first hardened layer 410 are increased, and thus the powders are sintered. In the case where the binding force between the powder particles by the ink discharged from the head is insufficient, and the hardness of the object that has been modeled is insufficient, by performing heating with the first heater 40a, it is possible to obtain a desired hardness.

Then, by driving the first lifting and lowering unit 1023a and the second lifting and lowering unit 1023b, the first modeling stage 1022a and the second modeling stage 1022b are lowered by the predetermined layer thickness as shown in FIG. 19B. Next, the first rotation motor 38a is driven, thereby rotating the first supply roller 13a and the first leveling roller 14a. In FIGS. 19A to 19C, the rotation direction of those rollers is clockwise. By rotating the first supply roller 13a and the first leveling roller 14a, the powders 200 deposited on the first deposition plate 12a of the first supply box 11a of the first supply unit 10a are flowed down via a gap between the lower end of the side wall of the first supply box 11a and the surface of the first supply roller 13a because of the self-weight of the powders 200 and the rotation force of the first supply roller 13a. As shown in FIG. 19C, the powders 200 that has been dropped are deposited as the second powder layer 411a on the first hardened layer 410 on the second modeling stage 1022b, and deposited as a third powder layer 312a on the second hardened layer 311 on the first modeling stage 1022a.

Further, by the driving of the movement mechanism 26, the first modeling unit 1020a and the second modeling unit 1020b are started to move toward the inkjet head 32 side approximately at the same time when the first supply roller 13a and the first leveling roller 14a are started to rotate or after a lapse of a predetermined time period from the timing. The rotations of the first supply roller 13a and the first leveling roller 14a are continued also during the movement of the first modeling unit 1020a and the second modeling unit 1020b, and the supply of the powders 200 to the first modeling box 1021a and the second modeling box 1021b is continued.

When the first modeling unit 1020a and the second modeling unit 1020b are moved to cause the first leveling roller 14a to be located above the first modeling box 1021a and the second modeling box 1021b, the surface of the powders 200 is leveled.

Next, when the movement of the first modeling unit 1020a and the second modeling unit 1020b cause the first modeling box 1021a and the second modeling box 1021b to be moved to a predetermined position, the inkjet head 32 starts to discharge the ink based on the control of the head scan controller. As a result, a second hardened layer 411 is formed which is obtained by hardening a predetermined selected area of the second powder layer 411a deposited on the second modeling stage 1022b. Subsequently, by the discharge of the ink, a third hardened layer 312 is formed which is obtained by hardening a predetermined selected area of the third powder layer 312a deposited on the first modeling stage 1022a.

When the rear end portion (left end portion) of the moving first modeling box 1021a passes below the first leveling roller 14a, the first supply roller 13a and the first leveling roller 14a are stopped. Thus, the supply of the powders 200 to the first modeling box 1021a is stopped.

Further, when the inkjet head 32 supplies the ink to the entire predetermined selected area of the powder layer, the discharge is stopped.

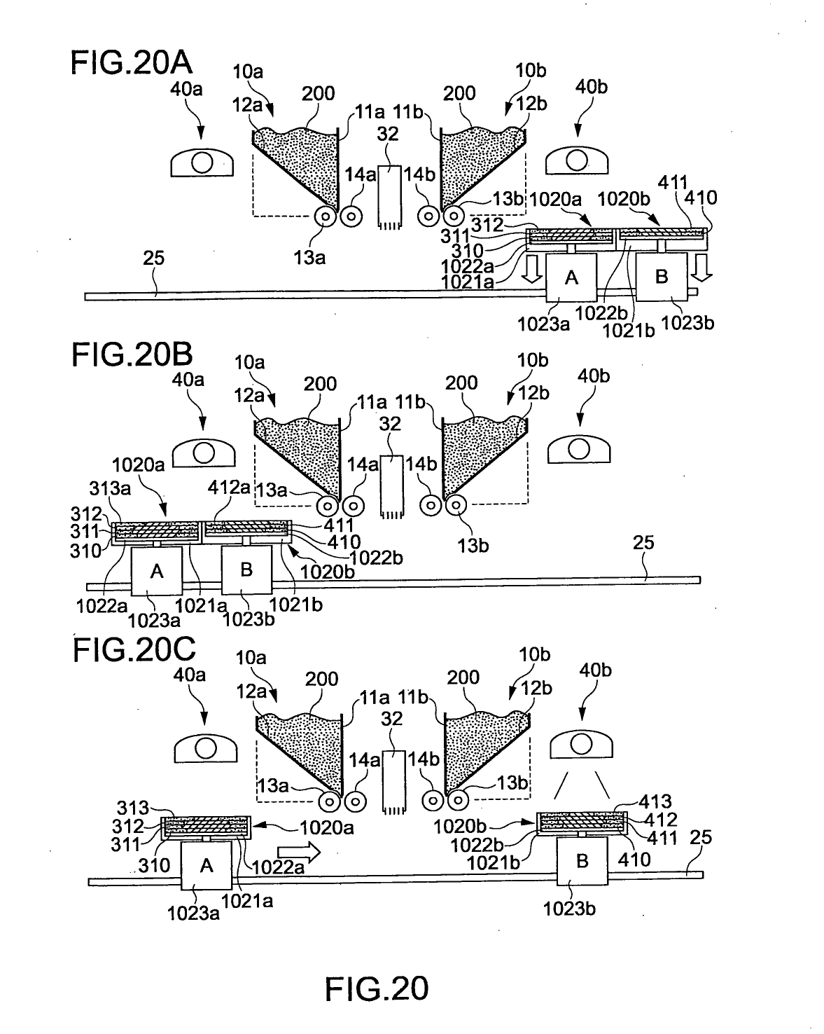

Further, the movement of the first modeling unit 1020a and the second modeling unit 1020b in the Y direction (rightwards in the figure) is further continued, the first modeling box 1021a and the second modeling box 1021b are moved to a position immediately below the second heater 40b as shown in FIG. 20A. In the position, the third hardened layer 312 on the first modeling stage 1022a and the second hardened layer 411 on the second modeling stage 1022b are heated by the second heater 40b. By the heating process, the hardness of the powders 200 in the hardened area of the third hardened layer 312 and the hardness of the powders 200 in the hardened area of the second hardened layer 411 are increased, and thus the powders are sintered.

Then, by driving the first lifting and lowering unit 1023a and the second lifting and lowering unit 1023b, the first modeling stage 1022a and the second modeling stage 1022b that have been returned to the position immediately below the second heater 40b are lowered by the predetermined layer thickness. Then, the first modeling unit 1020a and the second modeling unit 1020b are moved in the negative Y direction (leftwards in the figure), and the series of processes including the supply of the powders from the supply box, the discharge of the ink, and the heating with the heater is performed in the same way as above. As a result, as shown in FIG. 20B, a fourth hardened layer 313 as the last layer is formed on the first modeling stage 1022a, and a third hardened layer 412 is formed on the second modeling stage 1022b.

Next, the second modeling stage 1022b that has been returned to the position immediately below the first heater 40a is lowered by the predetermined layer thickness by driving the second lifting and lowering unit 1023b. Then, the second modeling unit 1020b is moved in the Y direction (rightwards in the figure), and the series of processes including the supply of the powders from the supply box, the discharge of the ink, and the heating with the heater is performed. As a result, as shown in FIG. 20C, a fourth hardened layer 413 is formed on the second modeling stage 1022b. When the second modeling stage 1022b is located immediately below the second heater 40b, the first modeling stage 1022a is located immediately below the first heater 40a. It should be noted that the heating of the hardened layer 313 on the first modeling stage 1022a with the first heater 40a may be performed concurrently with the heating of the hardened layer 413 on the second modeling stage 1022b with the second heater 40b. As a result, as shown in FIG. 20C, the fourth hardened layer 413 that is the last layer is formed on the second modeling stage 1022b. It should be noted that in this embodiment, although the fourth layer is the last layer in this embodiment, actually, the number of layers is 300 to 500 or more, and the series of processes is repeated until a desired number of modeled layers of the modeling data is obtained.

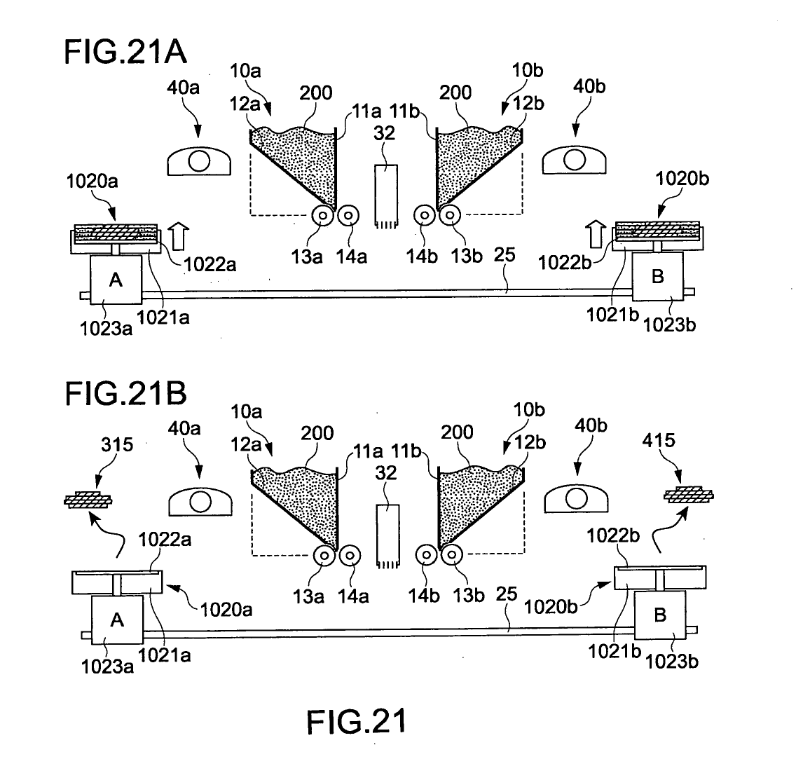

When the heating process is terminated, the host computer 51 judges whether the printing of all the tomographic images corresponding to the target object is completed or not. In the case where the printing is completed, 3-D objects are covered with an unhardened powder layer. The extra powders 200 in the first modeling box 1021a and the second modeling box 1022b are removed, with the result that the 3-D objects are completed. Then, as shown in FIG. 21A, the first modeling stage 1022a and the second modeling stage 1022b are returned, and as shown in FIG. 21B, 3-D objects 315 and 415 are taken out of the 3-D modeling apparatus 1100 manually or with a robot (not shown).

In the case where the printing of all the tomographic images corresponding to the target object is not completed, the first modeling unit 1020a (second modeling unit 1020b) is returned to the position immediately below the first heater 40a or the second heater 40b and moved in the Y direction or the negative Y direction, and the series of processes including the supply of the powders, the discharge of the ink, and the heating with the heater is repeated.

As described above, the two modeling units may be provided. With this structure, it is possible to obtain the same two 3-D objects at the same time in the one 3-D modeling apparatus. As a result, it is possible to reduce the modeling time period. It should be noted that the 3-D objects formed in the modeling units are the same in this case, but it is also possible to form two 3-D objects, the shapes of which are different, by controlling the discharge of the ink from the inkjet head 32.

### Other Embodiments

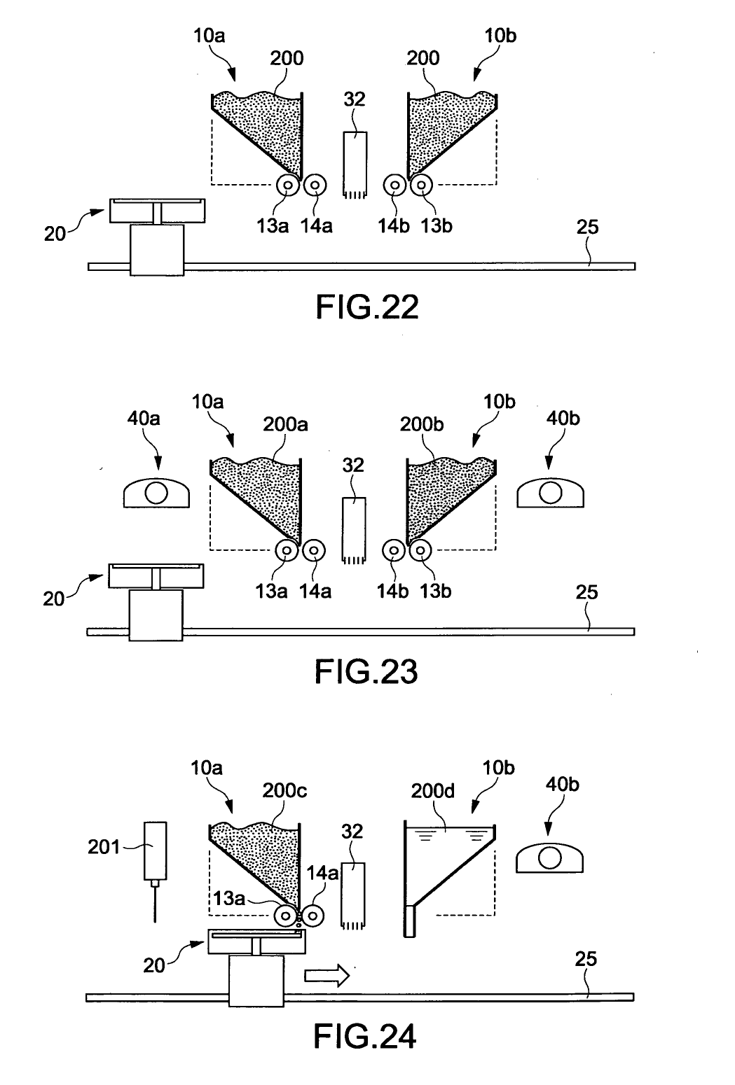

The present invention is not limited to the above embodiments, and other various embodiments are conceivable. A description will be given on other embodiments with reference to FIGS. 22 to 27. FIGS. 22 to 24 are schematic diagrams each showing another 3-D modeling apparatus. It should be noted that structures that are the same as those of the above embodiments are denoted by the same reference numerals and symbols, and their description will be omitted. Different points will be mainly described.

Although the first heater 40a and the second heater 40b are provided in the above embodiments, the heaters 40a and 40b may not be necessarily provided as shown in FIG. 22. A heating apparatus that heats a 3-D object obtained by a 3-D modeling apparatus that is not equipped with the heaters 40a and 40b may be provided separately from the 3-D modeling apparatus.

Although in the first embodiment, the materials of the powders stored in the first supply box 11a and the second supply box 11b are the same, the materials of powders 200a and powders 200b that are stored in the first supply box 11a and the second supply box 11b, respectively, may be different. Further, the materials of the powders 200a and 200b stored are the same, but particle diameters thereof may be different.

In the above embodiments, the modeling materials stored in the two supply boxes, i.e., the first supply box 11a and the second supply box 11b are powders but are not limited to the powders. For example, as shown in FIG. 24, powders 200c may be stored in one supply box, and a liquid 200d made of UV curable resin or the like may be stored in the other supply box. In the case where the liquid 200d is heated and hardened with a heating mechanism other than the heater, for example, a laser, the structure may be used in which a laser generator 201 is provided instead of the first heater 40a of the 3-D modeling apparatus 100 according to the first embodiment, and the second supply roller 13b and the second leveling roller 14b of the second supply unit 10b in which the liquid is stored are removed. That is, as shown in FIG. 24, in the movement direction of the modeling unit 20, the laser generator 201, the first supply unit 10a, the inkjet head 32, the second supply unit 10b, and the second heater 40b are arranged in the stated order from the left side of the figure. With this structure, when the modeling unit 20 is moved rightwards in the figure, the powders 200c are supplied onto the modeling stage 22 to form a powder layer, and the powder layer is hardened by ink discharged from the inkjet head 32, thereby forming a hardened layer. Further, the hardened layer is heated by the second heater 40b. In addition, when the modeling unit 20 is moved leftwards in the figure, the liquid 200d is supplied to the modeling stage 22, a liquid layer is formed, and the liquid layer is hardened by the laser generator 201. In the case where the liquid is used as the modeling material as in this embodiment, it is very effective to model a 3-D object by moving the stage with the supply mechanism being fixed in position. This is because in the case of the liquid material, when the supply mechanism that stores the liquid is moved, the surface of the liquid is moved, which may cause such a trouble that the liquid splashes toward the outside of the supply mechanism.

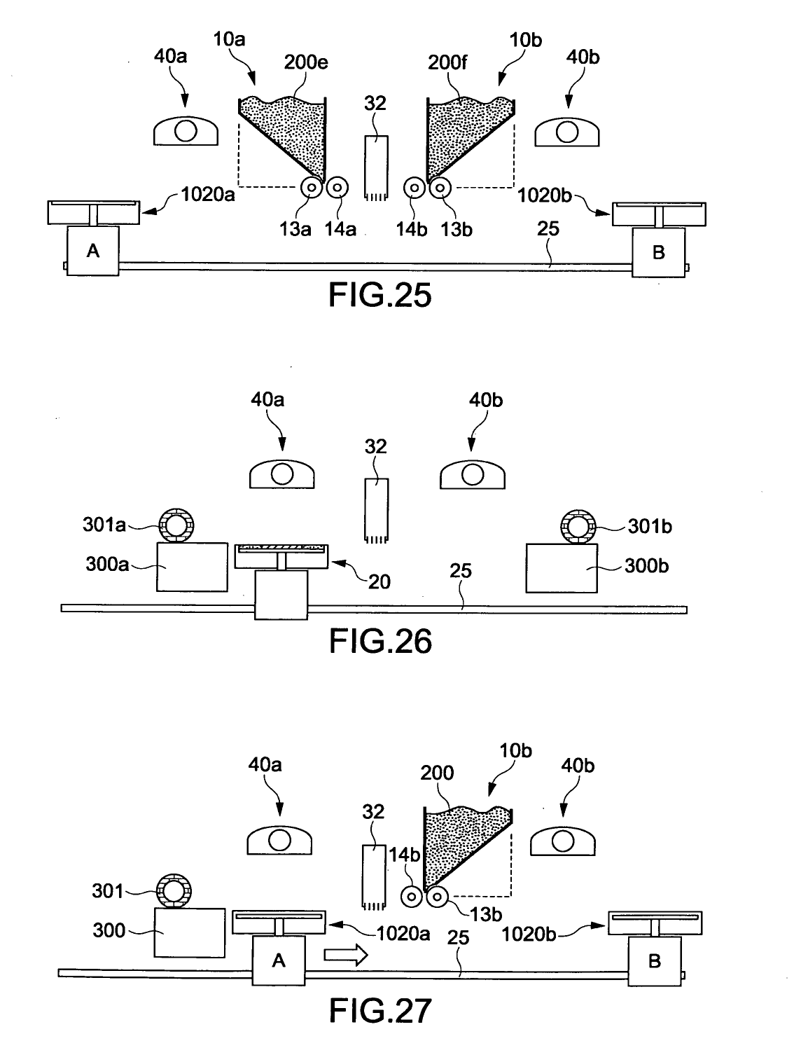

In the second embodiment, the materials of the powders stored in the first supply box 11a and the second supply box 11b are the same. However, as shown in FIG. 25, powders 200e and 200f stored in the first supply box 11a and the second supply box 11b, respectively, are made of different materials or the same material having different particle diameters.

In the first embodiment, the first supply unit 10a and the second supply unit 10b that serve as the powder supply mechanisms are located above the modeling stage 22. However, as shown in FIG. 26, those supply units may serve as powder supply mechanisms having such a configuration that powders are supplied from the same height as the modeling stage 22. As shown in FIG. 26, in the 3-D modeling apparatus according to this embodiment, a first material supply box 300a in which the powders are stored and a first material supply roller 301a are provided instead of the first supply unit 10a, and a second material supply box 300b in which the powders are stored and a second material supply roller 301b are provided instead of the second supply unit 10b. In the first material supply box 300a (second material supply box 300b), a first material supply stage (second material supply stage) (not shown) that is capable of being lifted and lowered is disposed. In the process of forming a hardened layer in the 3-D modeling apparatus, first, the modeling stage 22 is lowered by a predetermined amount. Next, the first material supply stage (second material supply stage) of the first material supply box 300a (material supply box 300b) is lifted by a predetermined amount. The first material supply roller 301a (second material supply roller 301b) is rotated, thereby pushing the powders stored in the first material supply box 300a (second material supply box 300b) to the modeling box 21 side, with the result that the modeling box 21 is filled with the powders. When the modeling box 21 is filled with the powder materials, the first material supply stage (second material supply stage) are moved, and ink is discharged from the inkjet head 32, thereby forming a hardened layer. As described above, the different powder supply mechanism may be used. In addition, such a configuration may be used that one powder supply mechanism is located above the modeling stage as in the case of the supply unit according to the first embodiment, and the other powder supply mechanism is located at the same height as the modeling stage as in this embodiment.

In the second embodiment, the first supply unit 10a and the second supply unit 10b that serve as the powder supply mechanisms are located above the modeling stage 22. However, such a configuration may be used that one of the powder supply mechanisms supplies the powders from the height as the modeling stage 22 as shown in FIG. 27. As shown in FIG. 27, in the 3-D modeling apparatus according to this embodiment, instead of the first supply unit 10a, the first material supply box 300 and the first material supply roller 301 are provided. In the material supply box 300, the material supply stage (not shown) capable of being lifted and lowered is located. The powder supply from the material supply box 300 is in the same way as the powder supply from the first material supply boxes 300a and 300b shown in FIG. 26. As described above, the different powder supply mechanisms may be used.

As described above, in the other embodiments, the modeling stage 22 is provided so as to be movable along the Y-axis, and the two material supply mechanisms are disposed along the movement direction. With this structure, it is possible to deposit two layers by one reciprocating movement of the modeling stage 22, which makes it possible to reduce the modeling time period as compared to the case where one material supply mechanism is provided.

The present application contains subject matter related to that disclosed in Japanese Priority Patent Application JP 2010-017934 filed in the Japan Patent Office on Jan. 29, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional modeling apparatus, comprising:
a stage to which a modeling material is supplied;
a movement mechanism to move the stage in a predetermined direction;
a first supply mechanism and a second supply mechanism that are disposed along the predetermined direction, the first supply mechanism and the second supply mechanism supplying the modeling material onto the stage that is moved by the movement mechanism; and
a head to discharge a liquid to the modeling material on the stage, the liquid being capable of hardening the modeling material supplied from at least one of the first supply mechanism and the second supply mechanism.

2. The three-dimensional modeling apparatus according to claim 1,
wherein the head discharges the liquid to the modeling material on the stage that is moved by the movement mechanism.

3. The three-dimensional modeling apparatus according to claim 2,
wherein the head is disposed between the first supply mechanism and the second supply mechanism along the predetermined direction.

4. The three-dimensional modeling apparatus according to claim 3,
wherein at least one of the first supply mechanism and the second supply mechanism includes
a supply box that is capable of storing the modeling material and is disposed above the stage in a movement path of the stage,
a deposition surface on which the modeling material is deposited, the deposition surface being disposed to be inclined in the supply box, and
a mechanism to cause, during movement of the stage, the modeling material deposited on the deposition surface to drop onto the stage by self-weight of the modeling material.

5. The three-dimensional modeling apparatus according to claim 1,
wherein the first supply mechanism and the second supply mechanism supply the same modeling material.

6. The three-dimensional modeling apparatus according to claim 1,
wherein the first supply mechanism and the second supply mechanism supply different modeling materials.

7. The three-dimensional modeling apparatus according to claim 1,
wherein the first supply mechanism and the second supply mechanism supply a modeling material that is a powder.

8. The three-dimensional modeling apparatus according to claim 1,
wherein the stage includes a plurality of stages.

9. A method of manufacturing a three-dimensional object, comprising:
moving a stage in a predetermined direction;
supplying, during movement of the stage, a modeling material onto the stage by a first supply mechanism and a second supply mechanism that are disposed along the predetermined direction; and
discharging a liquid to the modeling material on the stage, the liquid being capable of hardening the modeling material supplied from at least one of the first supply mechanism and the second supply mechanism.

10. A three-dimensional object obtained by a manufacturing method including
moving a stage in a predetermined direction,
supplying, during movement of the stage, a modeling material onto the stage by a first supply mechanism and a second supply mechanism that are disposed along the predetermined direction, and
discharging a liquid to the modeling material on the stage, the liquid being capable of hardening the modeling material supplied from at least one of the first supply mechanism and the second supply mechanism.
